(19) United States
(12) Patent Application Publication
(10) Pub. No.: US 2026/0349844 A1
(43) Pub. Date: Nov. 5, 2026

(54) LOW CODE OR NO CODE API ORCHESTRATION GATEWAY FEATURES

(71) Applicant: KONG INC., San Francisco, CA (US)

(72) Inventors: Hisham Hashem Muhammad, Porto Alegre (BR); Thomas Eugene Brightbill, II, Carlsbad, CA (US)

(21) Appl. No.: 19/199,157

(22) Filed: May 5, 2025

(51) Int. Cl. G06F 9/54; G06F 8/34

(52) U.S. Cl. CPC G06F 9/54; G06F 8/34

(57) ABSTRACT

The technology discloses systems, methods, and computer-readable media for orchestrating an execution order of a plurality of application programming interfaces (APIs) using an API gateway to a microservices application. An API gateway receives a set of API orchestration conditions from a user in a low-code or no-code format. The API gateway converts the set of API orchestration conditions into executable code that, when executed, assigns API requests and responses received at the API gateway to execute in a specific order. The API gateway receives an API request from a client and executes the executable code, thereby assigning the API request to execute according to the specific order.

### BACKGROUND

Microservices are a software development technique—a variant of the service-oriented architecture (SOA) architectural style that structures an application as a collection of small, independent processes/services that communicate with each other through predefined application programming interfaces (APIs). In a microservices architecture, services are fine-grained and the protocols are lightweight. The benefit of decomposing an application into different smaller services is that it improves modularity. This makes the application easier to understand, develop, test, and become more resilient to architecture erosion. Microservices parallelize development by enabling small autonomous teams to develop, deploy, and scale their respective services independently. Microservice-based architectures enable continuous delivery and deployment.

An API gateway in a microservice architecture acts as an entry point for incoming client requests and routes the requests to the appropriate microservice as they are received. API gateways handle authentication, rate limiting, logging, and other cross-cutting concerns.

Various network nodes may be included in and/or communicate with API gateways, such as proxies, data planes, and control planes. Proxies operate linked to each API. The proxy attached to each API is referred to as a “data plane proxy.” Examples of a data plane proxy include the sidecar proxies of Envoy proxies. The control plane monitors the operations of the APIs (e.g., microservices) based on output data received from the APIs and communicates settings and input data with the APIs to run one or more microservice architecture applications. Data planes route client traffic from a proxy. Control planes draw the network topology or the routing table that defines what to do with incoming packets. Control plane logic can also define certain packets to be discarded, as well as preferential treatment of certain packets for which a high quality of service is defined by such mechanisms as differentiated services. In a microservices architecture, the control plane operates between each API that makes up the microservice architecture.

Plugins, short for “plug-in software” or “add-ons,” are modular components that extend the functionality of a software application by providing additional features or capabilities. Plugins follow a modular design, allowing developers to create and distribute them separately from the core application. Plugins interface with the client application through predefined APIs or hooks in the software's architecture, allowing the plugin to access and augment the functionalities of the client application.

### BRIEF DESCRIPTION OF THE DRAWINGS

FIG. 1A illustrates a prior art approach with multiple APIs having functionalities common to one another.

FIG. 1B illustrates a distributed API gateway architecture according to an embodiment of the disclosed technology.

FIG. 2 illustrates a block diagram of an example environment suitable for functionalities provided by a gateway node according to an embodiment of the disclosed technology.

FIG. 3A illustrates a block diagram of an example environment suitable for functionalities provided by a gateway node according to an embodiment of the disclosed technology.

FIG. 3B illustrates a schematic of a data store shared by multiple gateway nodes according to an embodiment of the disclosed technology.

FIG. 4A and FIG. 4B illustrate example block diagrams and show ports and connections of a gateway node according to an embodiment of the disclosed technology.

FIG. 5 illustrates a flow diagram showing steps of a process involved in installation of a plugin at a gateway node according to an embodiment of the disclosed technology.

FIG. 6 illustrates a sequence diagram showing components and associated steps involved in loading configurations and code at runtime according to an embodiment of the disclosed technology.

FIG. 7 is a block diagram of a control plane system for a service mesh in a microservices architecture.

FIG. 8 is a block diagram illustrating an example environment of a control plane and a plurality of microservices in a microservice architecture application.

FIG. 9 is a block diagram illustrating the tracing of service groups by a control plane.

FIG. 10 is a flowchart illustrating a method performed by an API gateway for executing an API request according to a set of API orchestration conditions.

FIG. 11 is an illustration of an example gateway customization GUI for selecting features to include in an API gateway.

FIG. 12 is a flowchart illustrating a method for deploying a customized API gateway.

FIG. 13 is a block diagram illustrating an example computer system in accordance with one or more embodiments.

FIG. 14 is a high-level block diagram illustrating an example AI system in accordance with one or more embodiments.

### DETAILED DESCRIPTION

Embodiments of the present disclosure are directed at systems, methods, and computer-readable media for the generation and deployment of customizable API gateways for microservices applications. The API gateway architecture is a distributed cluster of gateway nodes that jointly provide microservices and the plurality of APIs. Providing the APIs includes providing a plurality of plugins that implement the APIs. As a result of a distributed architecture, the task of API management can be distributed across a cluster of gateway nodes. Every request being made to an API hits a gateway node first, and then the request is proxied to the target API. The gateway nodes effectively become the entry point for every API-related request. The disclosed embodiments are well-suited for use in mission-critical deployments at small and large organizations. Aspects of the disclosed technology do not impose any limitation on the type of APIs. For example, these APIs can be proprietary APIs, publicly available APIs, or invite-only APIs.

The invention is implemented in numerous ways, including as a process, an apparatus, a system, a composition of matter, a computer program product embodied on a computer-readable storage medium, and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description that references the accompanying figures follows. The scope of the invention is limited only by the claims, and the invention encompasses numerous alternatives, modifications, and equivalents. Numerous specific details are set forth in the following description in order to provide a thorough understanding of the disclosure. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

### Gateway Environments

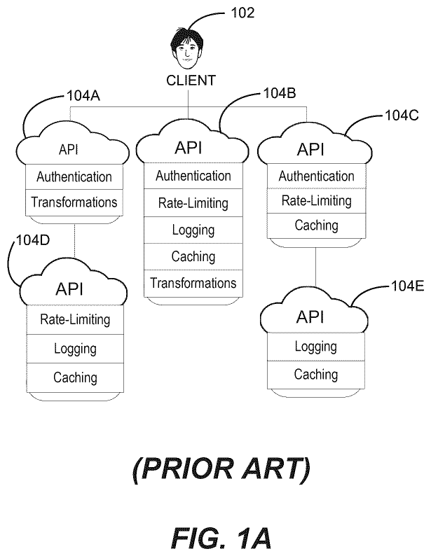

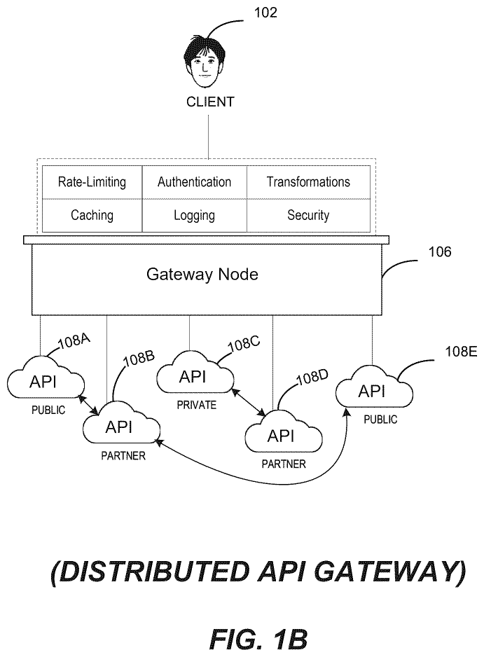

FIG. 1A illustrates a prior art approach with multiple APIs having functionalities common to one another. As shown in FIG. 1A, a client 102 is associated with APIs 104A, 104B, 104C, 104D, and 104E. Each API has a standard set of features or functionalities associated with it. For example, the standard set of functionalities associated with API 104A are “authentication” and “transformations.” The standard set of functionalities associated with API 104B are “authentication,” “rate-limiting,” “logging,” “caching,” and “transformations.” Thus, “authentication” and “transformations” are functionalities that are common to APIs 104A and 104B. Similarly, several other APIs in FIG. 1A share common functionalities. However, it is noted that having each API handle its own functionalities individually causes duplication of efforts and code associated with these functionalities, which is inefficient. This problem becomes significantly more challenging when there are tens of thousands of APIs and millions of clients requesting API-related services per day.

FIG. 1B illustrates a distributed API gateway architecture according to an embodiment of the disclosed technology. To address the challenge described in connection with FIG. 1A, the disclosed technology provides a distributed API gateway architecture as shown in FIG. 1B. Specifically, disclosed embodiments implement common API functionalities by bundling the common API functionalities into a gateway node 106 (also referred to herein as an API gateway). Gateway node 106 implements common functionalities as a core set of functionalities that run in front of APIs 108A, 108B, 108C, 108D, and 108E. The core set of functionalities include rate limiting, caching, authentication, logging, transformations, and security. It will be understood that the above-mentioned core set of functionalities are for examples and illustrations. There can be other functionalities included in the core set of functionalities besides those discussed in FIG. 1B. In some applications, gateway node 106 can help launch large-scale deployments in a very short time at reduced complexity and is therefore an inexpensive replacement for expensive proprietary API management systems. The disclosed technology includes a distributed architecture of gateway nodes, with each gateway node bundled with a set of functionalities that can be extended depending on the use case or applications.

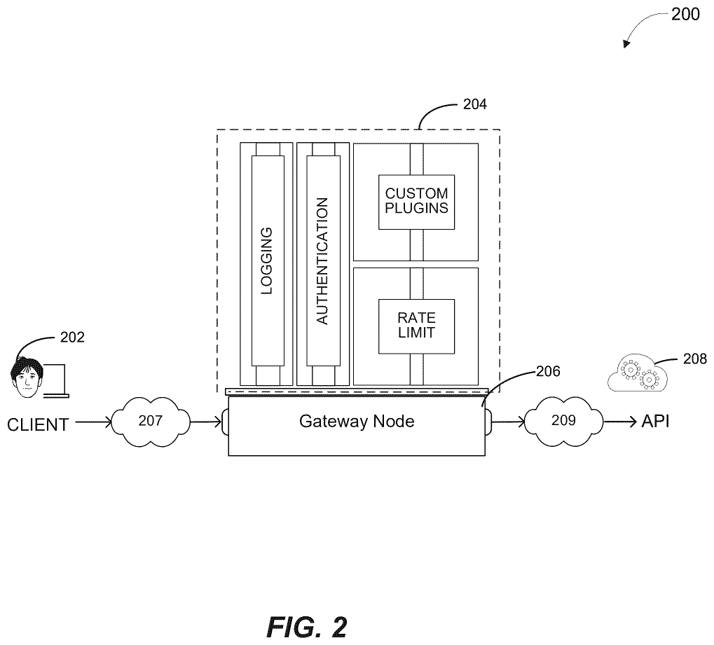

FIG. 2 illustrates a block diagram of an example environment suitable for functionalities provided by a gateway node according to an embodiment of the disclosed technology. In some embodiments, a core set of functionalities are provided in the form of “plugins” or “add-ons” installed at a gateway node. Generally, a plugin is a component that allows modification of what a system can do, usually without forcing a redesign/compile of the system. When an application supports plugins, it enables customization. The common examples are the plugins used in web browsers to add new features such as search engines, virus scanners, or the ability to utilize a new file type, such as a new video format.

As an example, a set of plugins 204 shown in FIG. 2 are provided by gateway node 206 positioned between a client 202 and one or more HTTP APIs. Electronic devices operated by client 202 can include, but are not limited to, a server desktop, a desktop computer, a computer cluster, a mobile computing device such as a notebook, a laptop computer, a handheld computer, a mobile phone, a smartphone, a PDA, a BlackBerry™ device, a Treo™, and/or an iPhone or Android device, etc. Gateway node 206 and client 202 are configured to communicate with each other via network 207. Gateway node 206 and one or more APIs 208 are configured to communicate with each other via network 209. In some embodiments, the one or more APIs reside in one or more API servers, API data stores, or one or more API hubs. Various combinations of configurations are possible.

Networks 207 and 209 can be any collection of distinct networks operating wholly or partially in conjunction to provide connectivity to/from client 202 and one or more APIs 208. In one embodiment, network communications can be achieved by an open network, such as the Internet, or a private network, such as an intranet and/or the extranet. Networks 207 and 209 can be a telephonic network, an open network, such as the Internet, or a private network, such as an intranet and/or the extranet. For example, the Internet can provide file transfer, remote login, email, news, RSS, and other services through any known or convenient protocol, such as, but not limited to, the TCP/IP protocol, Open System Interconnections (OSI), FTP, UPnP, iSCSI, NSF, ISDN, PDH, RS-232, SDH, SONET, etc.

Client 202 and one or more APIs 208 can be coupled to the networks 207 and/or 209 via a dial-up connection, a digital subscriber loop, a cable modem, wireless connections, and/or other types of connection. Thus, client devices can communicate with remote servers (e.g., API servers, hub servers, mail servers, instant messaging servers, etc.) that provide access to user interfaces of the World Wide Web via a web browser, for example.

The set of plugins 204 include authentication, logging, rate limiting, and custom plugins, of which authentication, logging, traffic control, and rate limiting can be considered as the core set of functionalities. An authentication functionality can allow an authentication plugin to check for valid login credentials such as usernames and passwords. A logging functionality of a logging plugin logs data associated with requests and responses. A traffic control functionality of a traffic control plugin manages, throttles, and restricts inbound and outbound API traffic. A rate-limiting functionality can allow managing, throttling, and restricting inbound and outbound API traffic. For example, a rate-limiting plugin can determine how many HTTP requests a developer can make in a given period of seconds, minutes, hours, days, months, or years.

A plugin can be regarded as a piece of stand-alone code. After a plugin is installed at a gateway node, it is available to be used. For example, gateway node 206 can execute a plugin in between an API-related request and providing an associated response to the API-related request. One advantage of the disclosed system is that the system can be expanded by adding new plugins. In some embodiments, gateway node 206 can expand the core set of functionalities by providing custom plugins. Custom plugins can be provided by the entity that operates the cluster of gateway nodes. In some instances, custom plugins are developed (e.g., built from “scratch”) by developers or any user of the disclosed system. It can be appreciated that plugins, used in accordance with the disclosed technology, facilitate in centralizing one or more common functionalities that would be otherwise distributed across the APIs, making it harder to build, scale, and maintain the APIs.

Other examples of plugins can be a security plugin, a monitoring and analytics plugin, and a transformation plugin. A security functionality can be associated with the system restricting access to an API by whitelisting or blacklisting/whitelisting one or more consumers identified, for example, in one or more Access Control Lists (ACLs). In some embodiments, the security plugin requires an authentication plugin to be enabled on an API. In some use cases, a request sent by a client can be transformed or altered before being sent to an API. A transformation plugin can apply a transformations functionality to alter the request sent by a client. In many use cases, a client might wish to monitor request and response data. A monitoring and analytics plugin can allow monitoring, visualizing, and inspecting APIs and microservices traffic.

In some embodiments, a plugin is Lua code that is executed during the life cycle of a proxied request and response. Through plugins, functionalities of a gateway node can be extended to fit any custom need or integration challenge. For example, if a consumer of the disclosed system needs to integrate their API's user authentication with a third-party enterprise security system, it can be implemented in the form of a dedicated (custom) plugin that is run on every request targeting that given API. One advantage, among others, of the disclosed system is that the distributed cluster of gateway nodes is scalable by simply adding more nodes, implying that the system can handle virtually any load while keeping latency low.

One advantage of the disclosed system is that it is platform agnostic, which implies that the system can run anywhere. In one implementation, the distributed cluster can be deployed in multiple data centers of an organization. In some implementations, the distributed cluster can be deployed as multiple nodes in a cloud environment. In some implementations, the distributed cluster can be deployed as a hybrid setup involving physical and cloud computers. In some other implementations, the distributed cluster can be deployed as containers.

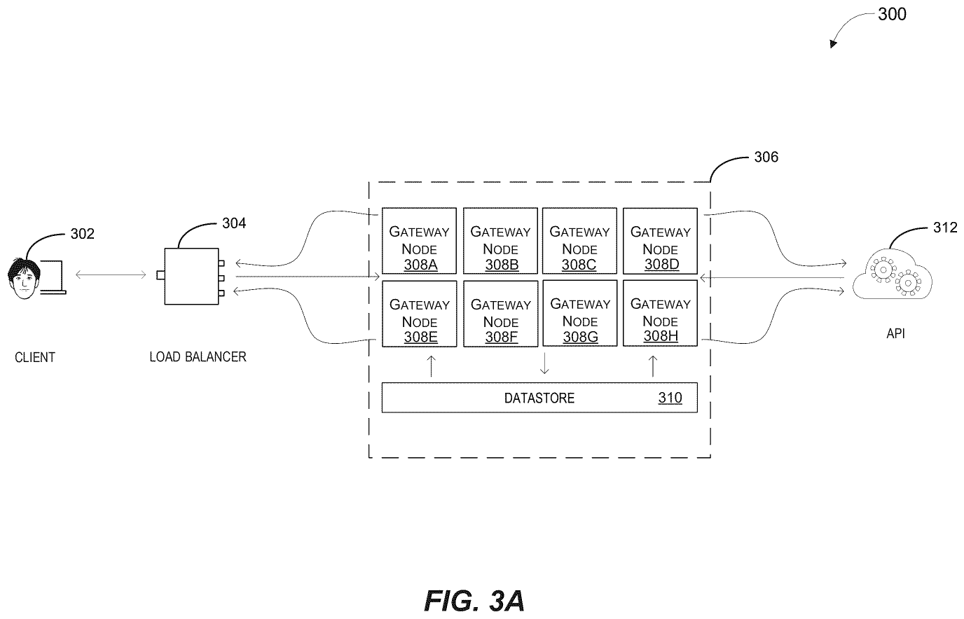

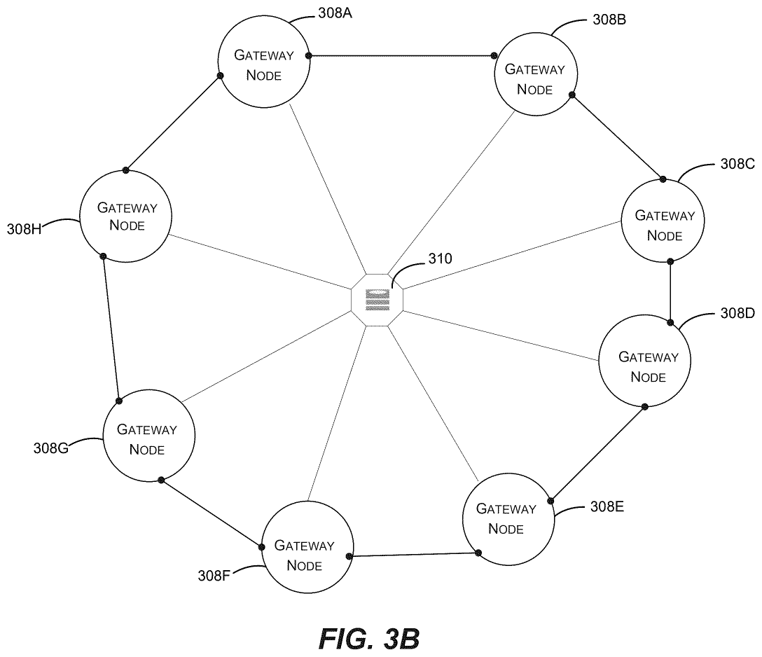

FIG. 3A illustrates a block diagram of an example environment 300 with a cluster of gateway nodes in operation. In some embodiments, a gateway node is built on top of NGINX. NGINX is a high-performance, highly scalable, highly available web server, reverse proxy server, and web accelerator (combining the features of an HTTP load balancer, content cache, and other features). In an example deployment, a client 302 communicates with one or more APIs 312 via load balancer 304 and a cluster of gateway nodes 306. The cluster of gateway nodes 306 can be a distributed cluster. The cluster of gateway nodes 306 includes gateway nodes 308A-308H and data store 310. The functions represented by the gateway nodes 308A-308H and/or the data store 310 can be implemented individually or in any combination thereof, partially or wholly, in hardware, software, or a combination of hardware and software.

Load balancer 304 provides functionalities for load balancing requests to multiple backend services. In some embodiments, load balancer 304 can be an external load balancer. In some embodiments, the load balancer 304 can be a DNS-based load balancer. In some embodiments, the load balancer 304 can be a Kubernetes® load balancer integrated within the cluster of gateway nodes 306.

Data store 310 stores all the data, routing information, plugin configurations, etc. Examples of a data store can be Apache Cassandra or PostgreSQL. In accordance with disclosed embodiments, multiple gateway nodes in the cluster share the same data store, e.g., as shown in FIG. 3A. Because multiple gateway nodes in the cluster share the same data store, there is no requirement to associate a specific gateway node with the data store—data from each gateway node 308A-308H is stored in data store 310 and retrieved by the other nodes (e.g., even in complex multiple data center setups). In some embodiments, the data store shares configurations and software codes associated with a plugin that is installed at a gateway node. In some embodiments, the plugin configuration and code can be loaded at runtime.

FIG. 3B illustrates a schematic of a data store shared by multiple gateway nodes, according to an embodiment of the disclosed technology. For example, FIG. 3B shows data store 310 shared by gateway nodes 308A-308H arranged as part of a cluster.

One advantage of the disclosed architecture is that the cluster of gateway nodes allow the system to be scaled horizontally by adding more gateway nodes to encompass a bigger load of incoming API-related requests. Each of the gateway nodes shares the same data since they point to the same data store. The cluster of gateway nodes can be created in one datacenter or in multiple datacenters distributed across different geographical locations in both cloud or on-premise environments. In some embodiments, gateway nodes (e.g., arranged according to a flat network topology) between the datacenters communicate over a Virtual Private Network (VPN) connection. The system can automatically handle a new gateway node joining a cluster or leaving a cluster. Once a gateway node communicates with another gateway node, it will automatically discover all the other gateway nodes due to an underlying gossip protocol.

In some embodiments, each gateway includes an administration API (e.g., internal RESTful API) for administration purposes. Requests to the administration API can be sent to any node in the cluster. The administration API can be a generic HTTP API. Upon setup, each gateway node is associated with a consumer port and an admin port that manages the API-related requests coming into the consumer port. For example, port number 8001 is the default port on which the administration API listens and 8444 is the default port for HTTPS (e.g., admin _listen_ssl) traffic to the administration API.

In some applications, it is possible that the data store only stores the configuration of a plugin and not the software code of the plugin. That is, for installing a plugin at a gateway node, the software code of the plugin is stored on that gateway node. This can result in inefficiencies because the user needs to update his or her deployment scripts to include the new instructions that would install the plugin at every gateway node. The disclosed technology addresses this issue by storing both the plugin and the configuration of the plugin. By leveraging the administration API, each gateway node can not only configure the plugins but also install them. Thus, one advantage of the disclosed system is that a user does not have to install plugins at every gateway node. Rather, the administration API associated with one of the gateway nodes automates the task of installing the plugins at gateway nodes by installing the plugin in the shared data store such that every gateway node can retrieve the plugin code and execute the code for installing the plugins. Because the plugin code is also saved in the shared data store, the code is effectively shared across the gateway nodes by leveraging the data store and does not have to be individually installed on every gateway node.

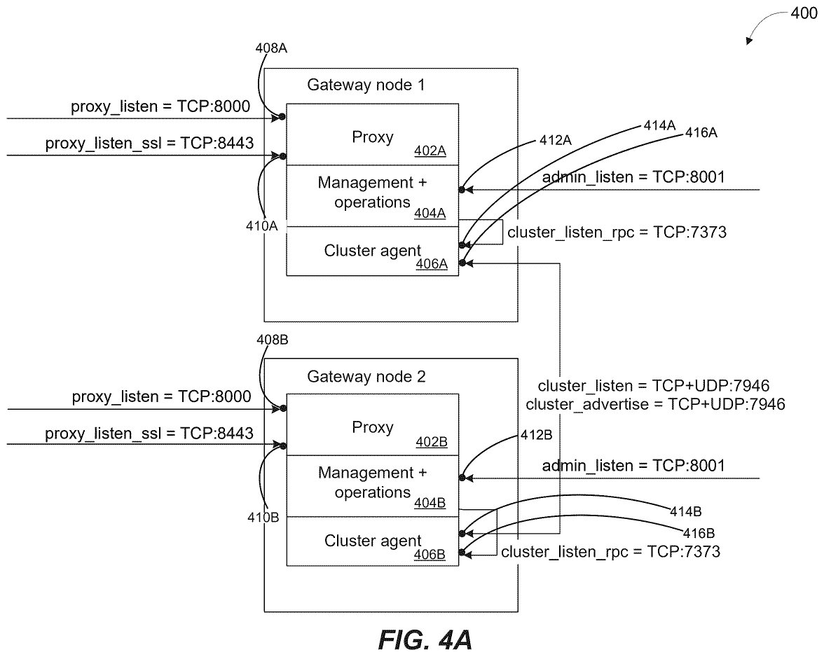

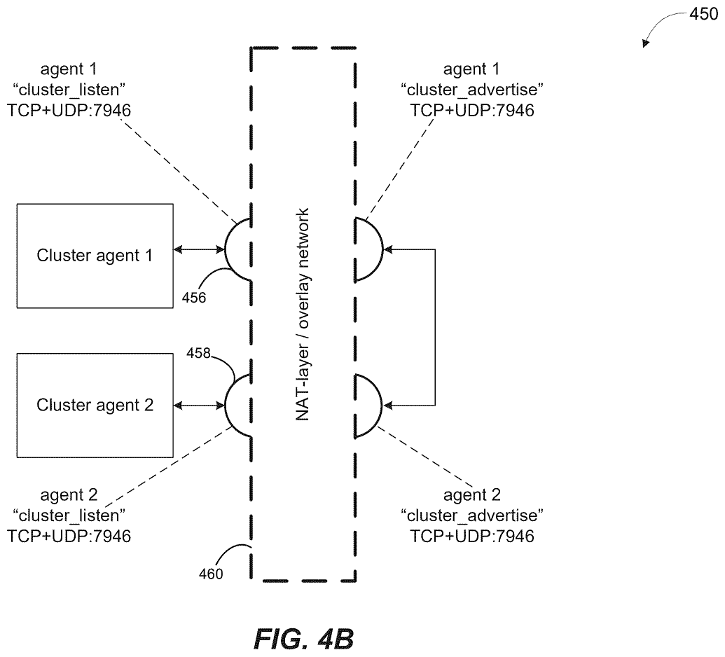

FIG. 4A and FIG. 4B illustrate example block diagrams 400 and 450 showing ports and connections of a gateway node according to an embodiment of the disclosed technology. Specifically, FIG. 4A shows a gateway node 1 and gateway node 2. Gateway node 1 includes a proxy module 402A, a management and operations module 404A, and a cluster agent module 406A. Gateway node 2 includes a proxy module 402B, a management and operations module 404B, and a cluster agent module 406B. Gateway node 1 receives incoming traffic at ports denoted as 408A and 410A. Ports 408A and 410A are coupled to proxy module 402B. Gateway node 1 listens for HTTP traffic at port 408A. The default port number for port 408A is 8000. API-related requests are typically received at port 408A. Port 410A is used for proxying HTTPS traffic. The default port number for port 410A is 8443. Gateway node 1 exposes its administration API (alternatively referred to as management API) at port 412A, which is coupled to management and operations module 404A. The default port number for port 412A is 8001.

The administration API allows configuration and management of a gateway node and is typically kept private and secured. Gateway node 1 allows communication within itself (i.e., intra-node communication) via port 414A, which is coupled to cluster agent module 406A. The default port number for port 414A is 7373. Because the traffic (e.g., TCP traffic) here is local to a gateway node, this traffic does not need to be exposed. Cluster agent module 406A of gateway node 1 enables communication between gateway node 1 and other gateway nodes in the cluster. For example, ports 416A and 416B, coupled with cluster agent module 406A at gateway node 1 and cluster agent module 406B at gateway node 2, allow intra-cluster or inter-node communication. Intra-cluster communication can involve UDP and TCP traffic. Both ports 416A and 416B have the default port number set to 7946.

In some embodiments, a gateway node automatically (e.g., without human intervention) detects its ports and addresses. In some embodiments, the ports and addresses are advertised (e.g., by setting the cluster_advertise property/setting to a port number) to other gateway nodes. It will be understood that the connections and ports (denoted with the numeral “B”) of gateway node 2 are similar to those in gateway node 1 and hence are not discussed herein.

FIG. 4B shows cluster agent 1 coupled to port 456 and cluster agent 2 coupled to port 458. Cluster agent 1 and cluster agent 2 are associated with gateway node 1 and gateway node 2, respectively. Ports 456 and 458 are communicatively connected to one another via a NAT-layer 460. In accordance with disclosed embodiments, gateway nodes are communicatively connected to one another via a NAT-layer. In some embodiments, there is no separate cluster agent, but the functionalities of the cluster agent are integrated into the gateway nodes. In some embodiments, gateway nodes communicate with each other using the explicit IP address of the nodes.

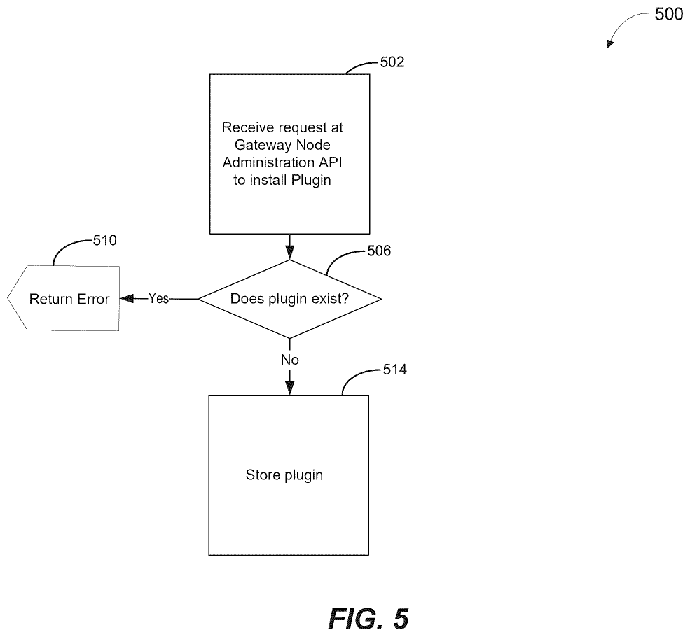

FIG. 5 illustrates a flow diagram showing steps of a process 500 involved in installation of a plugin at a gateway node according to an embodiment of the disclosed technology. At step 502, the administration API of a gateway node receives a request to install a plugin. An example of a request is provided below:

For example:
POST/plugins/install
name=OPTIONAL_VALUE
code=VALUE
archive=VALUE

The administration API of the gateway node determines (at step 506) if the plugin exists in the data store. If the gateway node determines that the plugin exists in the data store, then the process returns (at step 510) an error. If the gateway node determines that the plugin does not exist in the data store, then the process stores (at step 514) the plugin. (In some embodiments, the plugin can be stored in an external data store coupled to the gateway node, a local cache of the gateway node, or a third-party storage. For example, if the plugin is stored at some other location besides the data store, then different policies can be implemented for accessing the plugin.) Because the plugin is now stored in the database, it is ready to be used by any gateway node in the cluster.

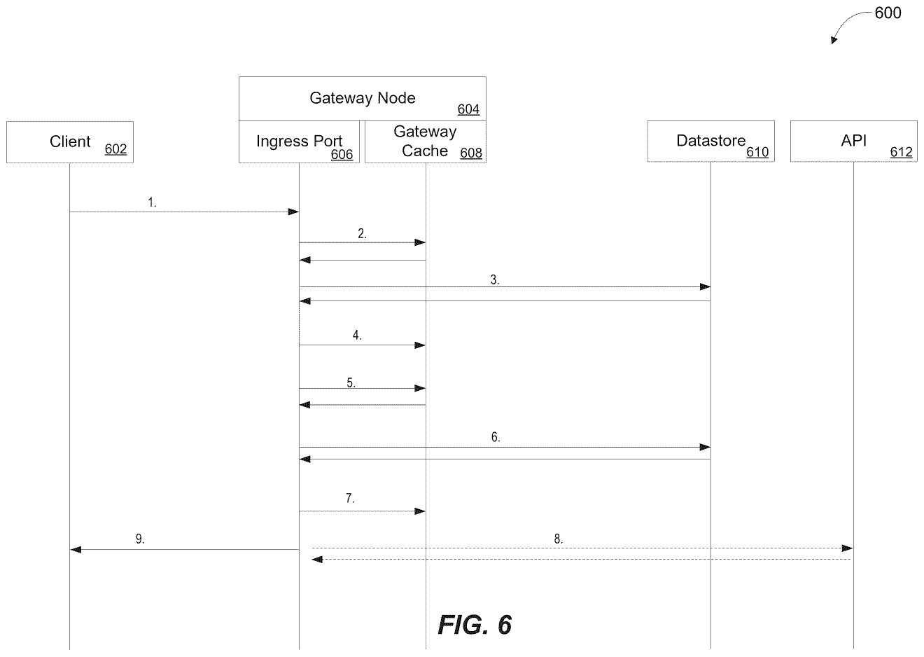

When a new API request goes through a gateway node (in the form of network packets), the gateway node determines (among other things) which plugins are to be loaded. Therefore, a gateway node sends a request to the data store to retrieve the plugin(s) that has/have been configured on the API and that need(s) to be executed. The gateway node communicates with the data store using the appropriate database driver (e.g., Cassandra or PostgreSQL) over a TCP communication. In some embodiments, the gateway node retrieves both the plugin code to execute and the plugin configuration to apply for the API and then executes them at runtime on the gateway node (e.g., as explained in FIG. 6).

FIG. 6 illustrates a sequence diagram 600 showing components and associated steps involved in loading configurations and code at runtime according to an embodiment of the disclosed technology. The components involved in the interaction are client 602, gateway node 604 (including an ingress port 606 and a gateway cache 608), data store 610, and an API 612. At step 1, a client makes a request to gateway node 604. At step 2, ingress port 606 of gateway node 604 checks with gateway cache 608 to determine if the plugin information and the information to process the request have already been cached previously in gateway cache 608. If the plugin information and the information to process the request are cached in gateway cache 608, then the gateway cache 608 provides such information to the ingress port 606. If, however, the gateway cache 608 informs the ingress port 606 that the plugin information and the information to process the request are not cached in gateway cache 608, then the ingress port 606 loads (at step 3) the plugin information and the information to process the request from data store 610. In some embodiments, ingress port 606 caches (for subsequent requests) the plugin information and the information to process the request (retrieved from data store 610) at gateway cache 608. At step 5, ingress port 606 of gateway node 604 executes the plugin and retrieves the plugin code from the cache for each plugin configuration. However, if the plugin code is not cached at the gateway cache 608, the gateway node 604 retrieves (at step 6) the plugin code from data store 610 and caches it (at step 7) at gateway cache 608. The gateway node 604 executes the plugins for the request and the response (e.g., by proxy the request to API 612 at step 7), and at step 8, the gateway node 604 returns a final response to the client.

### Gateway Control Planes

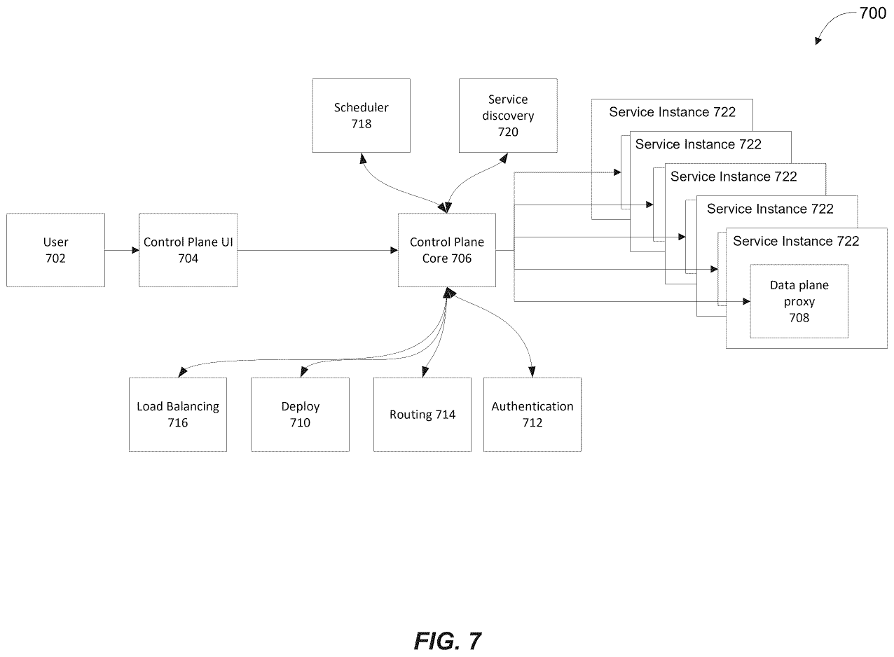

FIG. 7 is a block diagram of a control plane system 700 for a service mesh in a microservices architecture. In a microservices architecture, each microservice typically exposes a set of fine-grained endpoints as opposed to a monolithic application where there is just one set of (typically replicated, load-balanced) endpoints. An endpoint can be a URL pattern used to communicate with an API. A service mesh data plane is controlled by a control plane and processes every packet and request within the system, integrating all data planes into a cohesive distributed system. The service mesh data plane handles service discovery, health checking, routing, load balancing, authentication and authorization, observability, and policy/configuration for all active data planes within the mesh. The service mesh control plane does not process any packets or requests directly but collects packets and requests from the system.

A service mesh such as Linkerd, NGINX, HAProxy, and Envoy co-locate service instances with a data plane proxy network proxy. Network traffic (HTTP, REST, gRPC, Redis, etc.) from an individual service instance flows via its local data plane proxy to the appropriate destination. Thus, the service instance is not aware of the network at large and only knows about its local proxy. In effect, the distributed system network has been abstracted away from the service programmer. In a service mesh, the data plane proxy performs a number of tasks. Example tasks include service discovery, health checking, routing, load balancing, authentication and authorization, and observability.

Service discovery identifies each of the upstream/backend microservice instances within used by the relevant application. Health checking refers to detection of whether upstream service instances returned by service discovery are ready to accept network traffic. The detection may include both active (e.g., out-of-band pings to an endpoint) and passive (e.g., using 3 consecutive 5xx as an indication of an unhealthy state) health checking. The service mesh is further configured to route requests from local service instances to desired upstream service clusters.

Load balancing is a process in which a service mesh determines which upstream service instance should receive a request. Load balancing involves configuring timeout and circuit-breaking settings, as well as deciding whether a request should be retried in case of failure.

The service mesh further authenticates and authorizes incoming requests cryptographically using mTLS or some other mechanism. Data plane proxies enable observability features including detailed statistics and logging, and distributed tracing data should be generated so that operators can understand distributed traffic flow and debug problems as they occur. In effect, the data plane proxy is the data plane. Said another way, the data plane is responsible for conditionally translating, forwarding, and observing every network packet that flows to and from a service instance. The network abstraction that the data plane proxy provides does not inherently include instructions or built-in methods to control the associated service instances in any of the ways described above. Instead, the control features are enabled by a control plane, as described in more detail below.

A service mesh and control plane system 700 includes a user 702 who interfaces with a control plane UI 704. The UI 704 might be a web portal, a CLI, or some other interface. Through the UI 704, the user 702 has access to the control plane core 706. The control plane core 706 serves as a central point through which other control plane services operate in connection with the data plane proxies 708. Ultimately, the goal of a control plane is to set policy that will eventually be enacted by the data plane. More advanced control planes will abstract more of the system from the operator and require less handholding.

Control plane services may include global system configuration settings such as deploy control 710 (blue/green and/or traffic shifting), authentication and authorization settings 712, route table specification 714 (e.g., when service A requests a command, what happens), load balancer settings 716 (e.g., timeouts, retries, circuit breakers, etc.), a workload scheduler 718, and a service discovery system 720. The scheduler 718 is responsible for bootstrapping a service along with its data plane proxy. Service instances 722 are run on an infrastructure via some type of scheduling system (e.g., Kubernetes or Nomad). Typical control planes operate in control of control plane services 710-720 that, in turn, control the data plane proxies 708. Thus, in typical examples, the control plane services 710-720 are intermediaries to the service instances 722 and associated data plane proxies 708.

As depicted in FIG. 7, the control plane core 706 is the intermediary between the control plane services 710-720 and the data plane proxies 708. Acting as the intermediary, the control plane core 706 removes dependencies that exist in other control plane systems and enables the control plane core 706 to be platform agnostic. The control plane services 710-720 act as managed stores. With managed storages in a cloud deployment, scaling and maintaining the control plane core 706 involves fewer updates. The control plane core 706 can be split into multiple modules during implementation.

The control plane core 706 passively monitors each service instance 722 via the data plane proxies 708 via live traffic. However, the control plane core 706 may take active checks to determine the status or health of the overall application.

The control plane core 706 supports multiple control plane services 710-720 at the same time by defining which one is more important through priorities. Employing a control plane core 706 as disclosed aids control plane service 710-720 migration. Where a user wishes to change the control plane service provider (e.g., changing service discovery from Zookeeper-based discovery to Consul-based discovery), a control plane core 706 that receives the output of the control plane services 710-720 from various providers can configure each regardless of provider. Conversely, a control plane that merely directs control plane services 710-720 includes no such configuration store.

Another feature provided by the control plane core 706 is Static service addition. For example, a user may run Consul, but they want to add another service/instance (e.g., for debugging). The user may not want to add the additional service on the Consul cluster. Using a control plane core 706, the user may plug the file-based source with custom-definition multi-datacenter support. The user may expose the state hold in control plane core 706 as an HTTP endpoint and plug the control plane core 706 from other datacenters as a source with lower priority. This will provide fallback for instances in the other datacenters when instances from a local datacenter are unavailable.

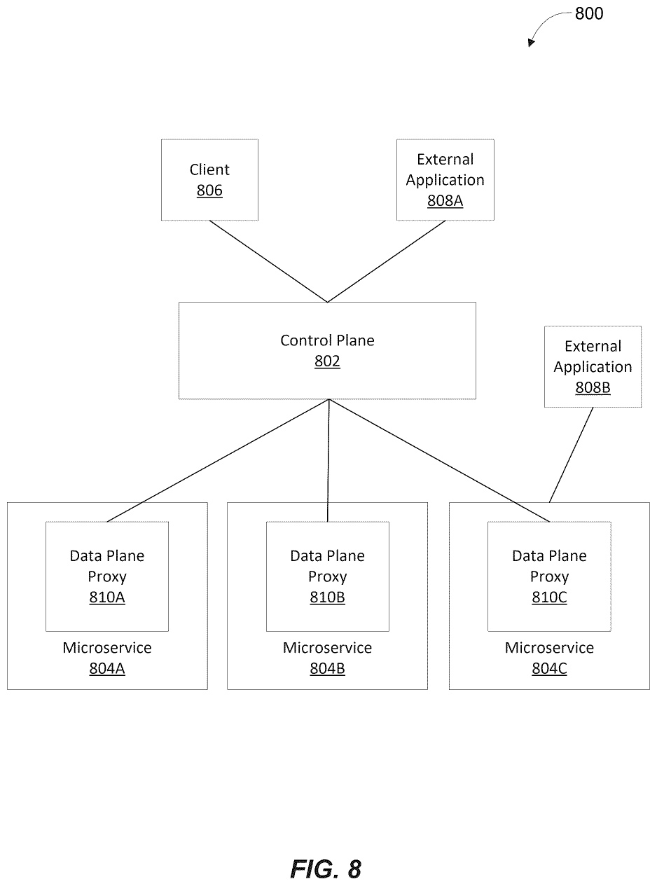

FIG. 8 is a block diagram illustrating an example environment 800 of a control plane 802 and a plurality of microservices 804 in a microservice architecture application. The control plane 802 is connected to a plurality of microservices 804, a client 806, and an external application 808A (referred to collectively herein as components). In some embodiments, the control plane 802 connects to the components via a network. The network may be the same as or generally similar to the networks 207 and 209 described in relation to FIG. 2 above. In some embodiments, additional or alternative components to those shown in FIG. 8 are connected (either directly or via the network) to the control plane 802. For example, in some embodiments, any number of microservices 804, rather than the three shown in FIG. 8, connect to the control plane 802.

The microservice architecture application is a computer program that performs one or more functions. The microservice architecture application is facilitated by the control plane 802 such that processes for running the microservice architecture application are distributed among the plurality of microservices 804 connected to the control plane 802. In some embodiments, the control plane 802 facilitates the processing of multiple microservice architecture applications by distributing the processes for the microservice architecture applications across the plurality of microservices 804. For instance, the control plane 802 may break down the processing required for each microservice architecture application into a set of processes and determine for each process how much computing power, memory, storage, and the like is needed for performing the process.

The control plane 802 requests data indicating the ability (e.g., graphics processing units available, storage available, etc.) of one or more microservices 804 to run the processes and selects a microservice for each process based on this data. In addition, the control plane 802 monitors the ability of the microservices over time to redistribute processes among the microservices based on this data.

The control plane 802 monitors microservices 804 as the microservices 804 perform operations for the microservice architecture application. When instantiating the microservice architecture application, the control plane selects a plurality of microservices 804 to each perform a process for the microservice architecture application. The control plane 802 sends, to each microservice 804, instructions for configuring the settings of the microservice 804 to perform the process and send input data for the process. The control plane 802 stores a record of the instructions and the settings in a database. The database is located within the control plane 802. In alternate embodiments, the database is connected to the control plane 802 via the network. In some embodiments, the control plane 802 stores the record in relation to a time the instructions were sent. Further, the control plane 802 may store the data in relation to an identifier of the microservice 804 such that the control plane 802 can query the database with the identifier to retrieve instructions, settings, event hooks, plugins, and the like associated with the microservice 804.

In some embodiments, the control plane 802 communicates (e.g., sends input data for processing, sends instructions for setting configuration, and/or receives output data) with the microservices 804 via one or more data plane proxies 810. A data plane proxy 810 functions as an intermediary between the control plane 802 and one or more microservices 804 to provide security and privacy and control the requests sent between the control plane 802 and the microservices 804. The data plane proxies 810 function like the gateway nodes 206, 308, 604 described in relation to FIGS. 2-6 or the proxies 708 described in relation to FIG. 7. In some embodiments, a data plane proxy 810 serves as a gateway for a single microservice 804A of the plurality of microservices 804 employed for the microservice architecture application. For example, the data plane proxy 810 may function as a gateway between the microservice 804A and an external application 808, a client 806, and/or the control plane 802.

In other embodiments, a data plane proxy 810 serves as a gateway for a subset or all of the plurality of microservices employed for the microservice architecture application. Further, in certain embodiments, the data plane proxies 810 each store subsets of the database at the request of the control plane 802. For instance, the control plane 802 requests that a data plane proxy 810C store a subset of the database related to associated microservice 804C. Though data plane proxies 810 act as gateways for communication between the control plane 802 and microservices 804 in a plurality of embodiments, for simplicity, the communications are often described herein as occurring directly between the control plane 802 and the microservices 804.

The control plane 802 also links a client 806 with the plurality of microservices 804 for the microservice architecture application. The control plane 802 receives inputs from the client 806 and configures one or more of the microservices 804 based on the inputs to perform services for the microservice architecture application. For example, the control plane 802 receives an input from the client 806 that causes the control plane 802 to configure a first microservice 804A with an event hook, the latest version of a plugin, or a new plugin. The control plane 802 also communicates output data received from the microservices 804 to the client 806. Though only one client 806 is shown in FIG. 8, in some embodiments, the control plane 802 links any number of clients 806 to the plurality of microservices 804.

The control plane 802 further links an external application 808A to the plurality of microservices 804. The external application 808 is associated with an external system and communicates with the control plane 802 for the microservice architecture application. For example, in one embodiment, the external application 808 is a messaging program configured to send messages to the client (directly or via the control plane 802). The control plane 802 observes events that occur at the external application 808A such that the control plane 802 runs a handler when a particular event occurs at the external application 808A. The control plane 802 also requests information from the external application 808 for the microservices 804 and sends information about processes running at the microservices 804 to the external application 808. Though only one external application 808A is shown as being connected to the control plane 802 in FIG. 8, the control plane 802 is enabled to serve as a link between any number of external applications 808 and the plurality of microservices 804 as necessary based on the configuration of a subject microservice application.

In some embodiments, a microservice 804C of the plurality of microservices 804 connects to an external application 808B. The microservice 804C communicates with and/or observes output data from the external application 808B via a gateway node (such as gateway node 206 in FIG. 2) or via the network. In some embodiments, the microservice 804C monitors events that occur at the external application 808B. For example, the control plane 802 configures the microservice 804C to monitor the external application 808B for an event occurrence. The microservice 804C accesses output data from the external application 808B. When the microservice 804C determines that the event occurred at the external application 808B, the microservice 804C notifies that control plane 802. Though only one external application 808 is shown in FIG. 8, in other embodiments, the control plane 802 may link any number of external applications 808 to the plurality of microservices 804. In other embodiments than that shown in FIG. 8, any number of microservices 804 may be connected to the external application 808B or other external applications.

Each microservice 804 is an API (such as API 208 or API 312 or service instance 722) that performs actions for the microservice architecture application and is configurable based on communications received from the control plane 802. Each microservice 804 communicates with the control plane 802 via a data plane proxy 810 at the microservice 804. The control plane 802 sends configuration instructions and input data to each microservice 804 and receives output data from each microservice 804. However, the control plane 802 cannot directly observe a microservice's 804 settings, so the control plane 802 must request current settings from a microservice 804 to determine what settings the microservice 804 is operating under.

In some embodiments, a microservice 804 generates a set of data representing the current settings of the microservice 804 and sends the hashed current settings to the control plane 802 or an associated data plane proxy 810. Either of the microservice 804 or the data plane proxy 810 may apply a hashing algorithm to the current settings before sending the hashed current settings to the control plane 802. Additionally or alternatively, the control plane 802 may query one or more microservices 804 for their current settings. For example, the control plane 802 may periodically (e.g., at regular time intervals) request the current settings of each microservice 804. In another example, the control plane 802 requests the current settings in response to receiving a request from an external computing device (e.g., client 202) for the current settings of a microservice 804.

In some embodiments, as the control plane 802 receives outputs from the microservices 804 performing the processes, the control plane assesses the outputs to determine whether each microservice 804 is performing as expected based on the configurable settings of the microservice 804 stored by the control plane 802 in the database (henceforth referred to as the “deployed version” of the configurable settings of the microservice 804). Where the microservice 804 is not performing as expected, the control plane 802 requests the current settings of the microservice. For example, the control plane 802 may have instructed multiple microservices 804 to perform the same process. If control plane 802 is receiving outputs from one of the multiple microservices 804 that do not match the outputs of the other microservices 804, the control plane 802 determines that the microservice 804 is not performing as expected and requests its current settings.

The control plane 802 receives current settings from a queried microservice 804. In some embodiments, the control plane 802 accesses a deployed version of the configurable settings of the microservice 804 at the database. The deployed version describes the configurable settings the control plane 802 had stored for the microservice 804 when the control plane 802 sent the request. In some embodiments, the control plane 802 previously applied the hashing algorithm to its stored understanding of the microservice's configurable settings to obtain the deployed version stored at the database. In other embodiments, the control plane 802 obtains the hashing algorithm from the microservice 804 along with the current settings (or in response to a separate request) and applies the hashing algorithm to the deployed version. The control plane 802 compares the current settings received from the microservice 804 to the deployed version to determine whether the current settings and deployed version match.

If the current settings and deployed version match, the control plane 802 stores an indication of the match in the database. In some embodiments, the control plane 802 stores the indication in association with the identifier of the microservice 804. In further embodiments, the control plane stores the indication in association with a time that the comparison was performed. If the current settings and the deployed version do not match, the control plane 802 updates the deployed version in the database to match the current settings. In some embodiments, the control plane 802 sends instructions to the microservice 804 to alter its settings based on the process the microservice 804 is performing for the microservice architecture application. In other embodiments, the control plane 802 moves the process at the microservice 804 to a different microservice 804 suitable for running the process. The different microservice 804 may have current settings matching the deployed version, or the control plane 802 may instruct the different microservice 804 to configure itself with settings matching the deployed version.

In one example, the control plane 802 determines that the first microservice 804A is operating with outdated configuration settings by determining that the hashed current settings and hashed deployed version do not match one another. In response, the control plane 802 sends an update to the first microservice 804A to update its configurable settings to match the deployed version. The control plane iterates upon requesting and comparing the current settings of the first microservice 804A until the control plane 802 determines that the deployed version and current settings match.

The control plane 802 communicates information for the microservice architecture application with the client 806. The control plane 802 transmits GUIs with this information for display to the client 806. A graphical user interface (GUI) includes interactive elements that the client 806 may interact with to display the information for the microservice architecture application. The client 806 selects interactive elements based on the information desired to be displayed and to send input data to the control plane 802 for the microservice architecture application. For example, the client 806 inputs configurations for one or more selected microservices 804 via a GUI. Other actions made by the client 806 via the GUI include selecting an external application 808 to connect to the microservices 804, inputting selection criteria (e.g., geography, region, time zone, processing power, etc.) for which microservices 804 to employ for the microservice architecture application, and the like. The control plane 802 communicates information about the client's interactions with the GUI to the other components and updates the GUI based on the interactions and output data from the other components.

In some embodiments, the control plane 802 receives event hooks from the client 806. In such embodiments, the control plane 802 may additionally receive an identifier of a component to configure the event hook with or selection criteria for choosing a component to configure the event hook with. The selection criteria include a geographic region, time zone, time range, amount of available storage, and the like of the component. For example, the client 806 may send an indication that the event hook needs to be configured on a microservice 804 that is in the northern hemisphere.

The control plane 802 stores received event hooks in the database in association with an identifier of the internal component to be configured with the event hook. In some embodiments, when the client 806 does not indicate an internal component to configure the event hook with, the control plane 802 allocates an internal component based on selection criteria sent with the event hook and/or the ability of the internal component to run the handler. For instance, the control plane 802 determines whether each internal component has the necessary processing capabilities to run the handler and meets the selection criteria. If multiple internal components are available to run the handler, the control plane 802 selects among the internal components randomly or based on location of the client 806, historical data of the internal component, or any other criteria available for selection.

For each event hook, the control plane 802 configures the identified internal component with the event hook. In some embodiments, the control plane 802 accesses settings of the internal component and updates the settings so that the internal component runs the handler when the internal component receives an indication that the event occurred at the source. In other embodiments, the control plane 802 determines configuration instructions for configuring the internal component with the event hook and sends the configuration instructions to the internal component.

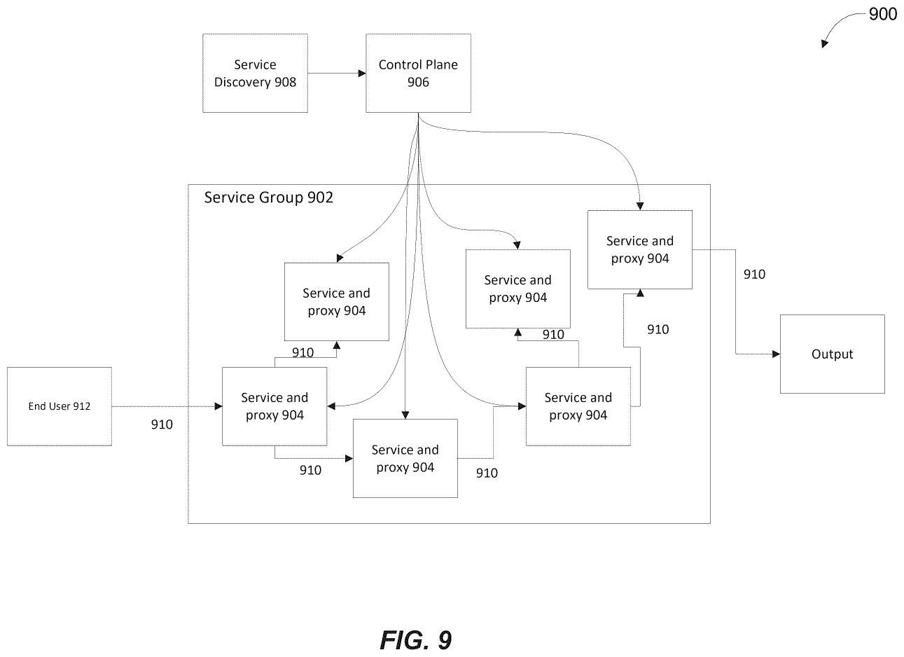

FIG. 9 is a block diagram illustrating the tracing 900 of service groups 902 by a control plane 906. A service group 902 is a group of services 904 that together perform an identifiable application purpose or business flow. For example, a set of microservices are responsible for an airline's ticketing portion of their website. Other examples may include “customer experience,” “sign up,” “login,” “payment processing,” etc. Using a control plane 906 with an associated service discovery 908 feature, packets are monitored as they filter through the overall application (e.g., whole website).

Given a starting point of a given service group 902, the control plane 906 may run a trace on packets having a known ID and follow where those packets (with the known ID) go in the microservice architecture as tracked by data plane proxies. In that way, the system can then automatically populate a service group 902 using the trace. The trace is enabled via the shared execution path of the data plane proxies. Along each step 910 between services 904, the control plane 906 measures latency and discover services. The trace may operate on live traffic corresponding to end users 912 or, alternatively, using test traffic.

As output, the control plane 906 generates a dependency graph of the given service group 902 business flow and reports via a graphic user interface (GUI). Using the dependency graph, a backend operator is provided insight into bottlenecks in the service group 902. For example, in a given service group 902, a set of services 904 may run on multiple servers that are operated by different companies (e.g., AWS, Azure, Google Cloud, etc.). The latency between these servers may slow down the service group 902 as a whole. Greater observability into the service group 902 via a dependency graph enables backend operators to improve the capabilities and throughput of the service group 902.

### Gateway Features

### Programmable Data Plane

The above embodiments describe a gateway node or API gateway that may execute one or more plugins. Absent other intervention, those plugins are executed upon request (e.g., by an API/microservice) or by chance based on when the processor of the API gateway picks up and executes instructions. In some cases, two plugins execute in parallel and create programmatic race conditions that lead to inefficient application execution. The execution of those plugins is thus uncontrolled and potentially problematic. Operations that execute out of order or in the wrong conditions become problematic to a program flow and cause error/crash/slowdown states. A solution is to configure execution ordering and condition decisions in native instructions within each plugin while configuring the API gateway to take into account the individual instructions of the installed plugin when executing the plugins.

An API gateway may include a programmable data plane feature enabling this solution. In embodiments where the API gateway includes this feature, the gateway is configured using a programmable data plane script, which is computer code that determines the order in which plugins are executed and conditions for repeated or conditional execution. For example, the programmable data plane script may include the overall execution order for a series of plugins, conditions under which certain plugins are executed or not, or conditions under which the execution of a certain plugin is repeated multiple times. The API gateway then executes the plugins in the order, and under the conditions, expressed by the programmable data plane script.

### Low-Code/No-Code API Orchestration

Similarly to the inefficiencies described above that occur when plugin execution order is uncontrolled, deploying an application without a controlled order of execution for various APIs of the application may result in errors, slower operation, and/or other deficiencies in application deployment. One process that is used for controlling the execution order of APIs is API orchestration, which integrates multiple APIs into a unified system where communications to/from those APIs move through a single access point. API orchestration sequences requests sent to the APIs and/or responses sent from those APIs to reduce inefficiencies such as race conditions/dependency errors that occur during parallel execution of certain APIs. API orchestration may also include the transformation of data into different formats (e.g., as an API request moves from frontend to backend) and/or the authentication/authorization of API traffic, enabling the formatting and security expectations of both a client and the APIs to be met more consistently.

Existing API gateway technologies either do not provide built-in API orchestration features or require the user to manually input large amounts of code in order to successfully orchestrate the APIs. A solution is to provide an API gateway that queues APIs to operate in a specific order in response to a low-code or no-code input from a user, enabling users to configure the API execution order using little or no manually written code.

Thus, in some embodiments, the API includes an API orchestration feature for orchestrating the execution order of APIs in a microservices application. This feature enables the API gateway to queue API operations in a desired execution order such that API requests are sent and responses are received back from APIs in an order that reduces error and conserves computational resources from being spent on repeated send operations. For example, the API gateway may receive requests for one or more APIs and maintain an internal queue where those requests are ordered based on one or more execution conditions specified by a user. Execution conditions are rules specifying the execution order of APIs in relation to one another, such as a rule for one API to execute before one or more other specified APIs, a rule for certain APIs to execute in parallel when race conditions between the APIs are unlikely to cause errors, a rule for an API to act at the beginning or end of the entire queue, or a rule for certain APIs to act in a predefined order while a specified application state, gateway state, and/or condition of the overall microservices application (e.g., a certain state of the application during execution associated with the core set of functionalities of a gateway, such as a certain load being processed or a certain security level) holds. Continuing with the same example, the API gateway may use a scheduler that processes the queued requests one by one or in parallel based on sorting rules, adhering to preferences set by the user while dynamically adjusting the execution order based on the real-time condition of the microservices application and dependencies between different APIs. In some embodiments, the API gateway may modify an API request (e.g., to have a format compatible with the API being requested) before the request is sent to the API as input.

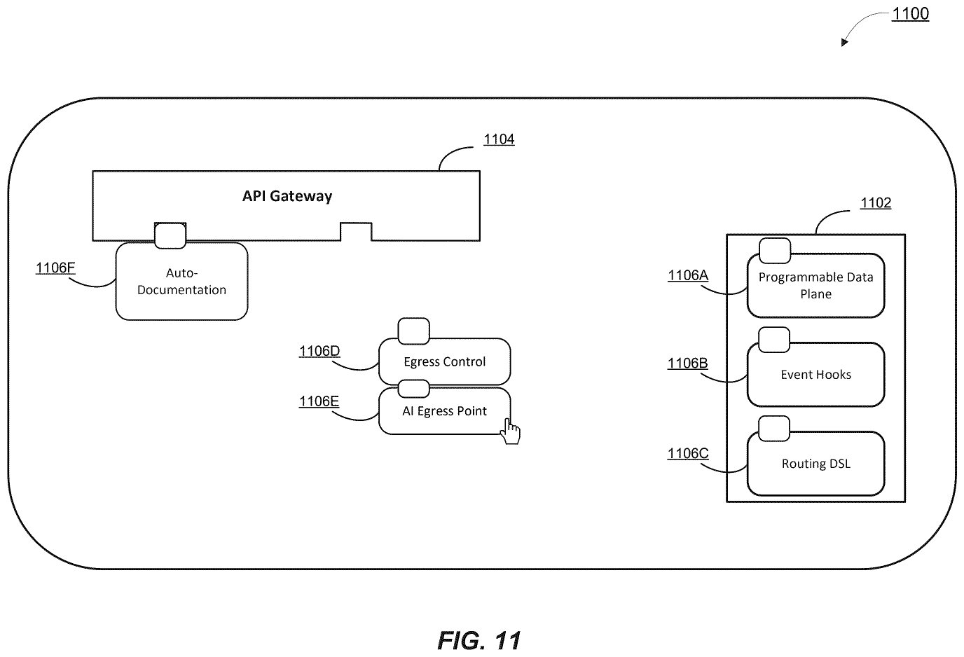

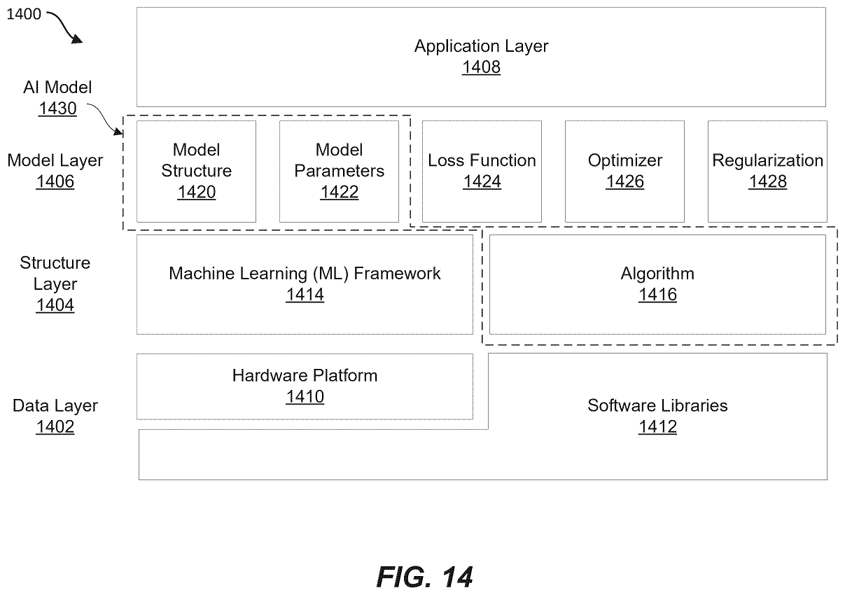

In some embodiments, the execution order for the APIs is determined by a user and provided to the API gateway via an interface. For example, the interface may be a block-based programming GUI enabling a user to select one or more blocks that users can visually arrange to indicate a desired execution order. The GUI may be generally similar to the gateway customization GUI depicted in FIG. 11 below, except that the blocks represent API requests rather than gateway features and connections between the blocks represent a desired execution order. As another example, a user may provide high-level instructions (e.g., in the form of a natural language text or audio input) to an AI model, which then generates detailed code to implement the desired execution order for the APIs as expressed by those instructions. The AI model may be one or more of the models described in relation to FIG. 14 below that may extract the user's intent from the instructions and output code representing the user's intended execution order. As a third example, the interface may be a low-code text interface that receives vague or minimal code snippets as input from a user, which describe the desired API execution order but are not executable code themselves. The API gateway may then translate these snippets into executable code that orchestrates the APIs to operate in the desired execution order.

By incorporating these methods, the API gateway provides a robust solution for orchestrating API execution, enhancing the efficiency and reliability of microservices applications.

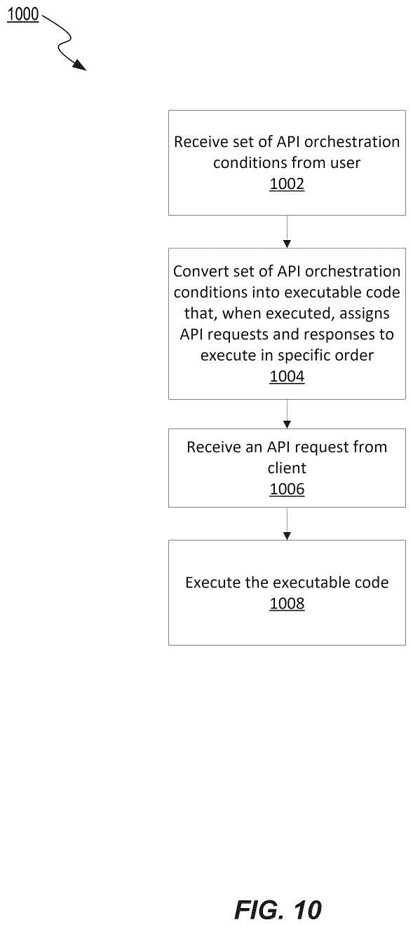

FIG. 10 is a flowchart illustrating a method 1000 performed by an API gateway for executing an API request according to a set of API orchestration conditions. In step 1002, the API gateway receives a set of API orchestration conditions from a user. In some embodiments, the API gateway is included in a microservices application along with a plurality of APIs that communicatively couple independent services within the microservices application. In these and other embodiments, the API orchestration conditions specify a relative order in which one or more APIs from a plurality of APIs included in a microservices application execute. For example, the set of API orchestration conditions may include at least one of a rule to execute a first API prior to execution of a second API, a rule to execute the first API after execution of a third API, a rule to execute the first API prior to execution of all APIs in the plurality of APIs, a rule to execute the first API after execution of all APIs in the plurality of APIs, a rule to execute the API prior to execution of a first functional group of APIs (e.g., a group of APIs performing a same or generally similar function within a microservices application), or a rule to execute the API after execution of a second functional group of APIs.

In some embodiments, the API orchestration conditions are indicated via a low-code or no-code format. Both low-code and no-code formats include pre-built segments of code that are selected by a user (e.g., via a drag-and-drop GUI) and arranged to represent a desired function of executable code. Low-code formats differ from no-code formats in that they may include custom scripts input (e.g., by a user or generated by an AI model) in addition to pre-built code segments. An example of a low-code format is a set of one or more scripts entered by the user via a text interface, with the scripts being incomplete code for the set of API orchestration conditions. Continuing with the same example, the scripts may be supplemented with pre-built code segments to form the logical structure of a block of code and provide instructions for the API gateway to convert the incomplete code, along with the pre-built code, into executable code. By contrast, an example of a no-code format is an arrangement of blocks representing pre-built code segments, which is arranged by a user via a block-based programming GUI. As another example of a no-code format, the set of API orchestration conditions may be indicated via a natural language input to an AI model including a description of the desired set of API orchestration conditions. Continuing with the same example, the natural language input is converted, using the AI model, into a programmable data plane script based on that input, which, when interpreted by the API gateway, implements the API orchestration conditions described in the natural language input. This programmable data plane script is then received and interpreted into executable code by the API gateway. The executable code is then executed when the API gateway receives API requests. A similar process may also serve as a low-code example where custom scripts are combined with the output of the AI model.

In step 1004, the API gateway converts the set of API orchestration conditions into executable code that, when executed, assigns API requests and responses received at the API gateway to execute in a specific order. In some embodiments, converting the set of API orchestration conditions into executable code includes interpreting a programmable data plane script that codifies the set of API orchestration conditions. In these and other embodiments, the executable code is executed by a processor of the API gateway or a processor of a different computing device communicatively coupled to the API gateway. The specific order may include a relative order of execution for a plurality of unexecuted API requests and API responses and is based on the set of API orchestration conditions. For example, the specific order may sequence execution such that two or more APIs only execute in parallel when race conditions/dependency errors do not occur. As another example, execution of operations involving high traffic may be spaced apart in the specific order such that traffic spikes, which may cause crashes or other errors, are reduced.

In some embodiments, the specific order is associated with the index of each API request/response in an internal queue of the API gateway, such that the API requests/responses are executed in order from the API request/response associated with the lowest index in the internal queue to the highest index in the internal queue. In these and other embodiments, the specific order is updated by the API gateway (e.g., the indexes of API requests/responses in the internal queue are changed) based on a change in conditions of the microservices application. A condition of the microservices application may include a certain state of the application during execution associated with the core set of functionalities of a gateway, such as a certain load being processed or a certain security level.

In step 1006, an API request is received from the client at the API gateway. The API request is a request for an API in the microservices application to execute. In step 1008, the API gateway executes the executable code from step 1004, thereby assigning the API request to execute according to the order specified by the received API orchestration conditions. Doing so enables the API to execute when the execution is less likely to result in error, conflict with other API executions, and/or repeat already executed operations. For example, the API may execute before one or more APIs that depend on information provided by the API and/or execute in parallel with one or more other APIs that, according to the API orchestration conditions, can execute simultaneously to the API without causing error.

In some embodiments, the API gateway sends a response from one API as input to another API as part of the API orchestration process. For example, the API gateway may send a second API request to a second API, where the second API request is earlier in a specific order of execution (e.g., based on a received set of API orchestration conditions) than a first API request for a first API. Continuing with the same example, a response from the second API may then be received by the API gateway and provided to the first API as input.

### Auto-Documentation

Documentation for an API is an informative text document that describes what functionality the API provides, the parameters it takes as input, what the output of the API is, how the API operates, and other such information. When releasing an API, documentation is typically a requisite in order for developers to learn how to consume the API, but documenting APIs can be a tedious and extensive task. In conventional systems, developers create an API and draft the documentation for the API. This approach to drafting a documentation for the API is human-driven, often resulting in the documentation not being updated in a timely manner. In some unwanted scenarios, the documentation does not match the implementation of the API. The issue of documentation is exacerbated in a microservices application that includes a large number of APIs that are independently updated and developed. While some technologies for the procedural generation of documentation exist, these technologies are often dependent on activation by the programmer who generates the source code or updates thereto.

A solution to the above deficiencies with documentation is to include an auto-documentation feature within an API gateway that automatically generates documentation for an API endpoint (e.g., input and output parameters of the API endpoint). By parsing a stream of requests from and responses to APIs passing through a gateway node, the feature generates the documentation automatically. In some embodiments, the auto-documentation feature is a plugin linked to an online repository of documentation, such as GitHub, and documentation files stored thereon are updated directly using provided login credentials where necessary. The auto-generated documentation is in a human-readable format so that developers can understand and consume the API.

In some embodiments, when the API undergoes changes or when the request/response (e.g., parameters included in the request/response) to the API undergoes changes, the API gateway detects the changes to the request/response. Detecting the changes enables the gateway to be able to alert/notify developers when API-related attributes change (e.g., in an event when the API is updated so that a field is removed from the API's response or a new field is added in the API's response) and generate/send updated auto-documentation. In some embodiments, to generate auto-documentation, a gateway node receives a client request and proxies the request to an API. After the API returns a response, the gateway node parses both the request and the response from the API and retrieves prior documentation for the API. The gateway node compares the prior documentation with the current request and response data to identify differences. When differences are detected, the gateway node determines whether the auto-documentation needs updating and may additionally alert the user. When the gateway node determines an update is required, the gateway node generates new auto-documentation for the current API transaction and stores the request and response meta-information (e.g., headers, parameters, body, etc.) in a data store or local cache.

### Self-Healing Architecture

In a microservices architecture, where a large number of API services interoperate, it is very difficult for a human to investigate and untangle the interrelations between services and identify issues. As applications become more complex and decoupled, the difficulty increases for human architects to make the right decisions when application performance degrades. Traditionally, when application issues or anomalies are recorded in a logging solution, an alert would be triggered for a human architect. Subsequently, the human architect must find out where the source of the problem in the application is and what caused the problem, and then put into action a solution to fix the problem. For example, if an unexpected problem has been introduced by the rollout of a new version of a component that the application depends upon, a solution would be to roll back the requests to the previous working version of the same component.

A more effective solution is including a self-healing feature in an API gateway of the microservices architecture. Self-healing, or intelligent healing, of the application makes use of the data plane proxies to collect real-time status about requests associated API services are processing, including (but not limited to) request rate, latency, and errors. By leveraging this information, the data plane of the API gateway can determine if an API or service that is being consumed (or that is consuming a third-party service) is healthy or not and communicate the health status to the control plane.

In some embodiments of the self-healing feature, the control plane of the API gateway receives application traffic data from data plane proxies and develops a benchmark state for the microservices application. The control plane then automatically recognizes and diagnoses an anomaly using the benchmark state and real-time application conditions. The control plane identifies the root cause of the anomaly (e.g., an observable characteristic of the application causing the anomaly) and executes a remedial action based on the root cause. In these and other embodiments, the API gateway may monitor application performance after executing the remedial action and execute secondary remedial actions when continued degradation is detected. This iterative process ensures continuous monitoring and resolution of anomalies to maintain or improve application performance.

### Routing Functionality of Gateways

An additional feature that may be included in an API gateway is an API routing domain-specific programming language (DSL) feature. Routing refers to a core tenet of a microservice architecture, where external clients invoke certain microservices indirectly via a gateway and/or an exposed node of the microservice architecture. By configuring various different routes that point to a particular microservice, for example, different requests forwarded by the gateway along the different routes can be discriminatively handled. As an example, different routes are managed by different rate-limiting policies, permission policies, authentication policies, and/or the like. Thus, routing provides an additional layer of control, security, and other technical benefits.

In some embodiments, routing data objects are definitions of routes. In particular, routing data objects include rules by which client requests are matched to a route. For a given route defined by a routing data object that includes matching rules, a client request satisfying the matching rules is handled according to the given route. Each routing data object is associated with a service, and in some examples, a service has multiple associated routing data objects. In some examples, a routing data object is associated with a service based on including a unique identifier for the service. The API gateway proxies every request that matches the routing data object to the service associated with (e.g., indicated by) the routing data object. In some embodiments, the routing data object includes a unique identifier (e.g., a name string, an incremented value, a hash value, a globally unique identifier, a universally unique identifier). The unique identifier for the routing data object is used to map the routing data objects to different policy actions.

Embodiments disclosed herein provide an API routing DSL feature that provides expressive definition, configuration, and interpretation of routing data objects. In particular, the routing DSL feature enables a routing data object to include and combine multiple complex matching rules for a more lightweight library of routing data objects. For example, an API gateway may use a routing DSL to route API messages by accessing a plurality of routing data objects configured according to the routing DSL and performing a matching operation between the API message and at least one routing data object from the plurality of routing data objects. Continuing with the same example, each matching operation includes evaluating, with the attributes of the API message, the one or more attribute condition statements of the match expression of the given routing data object and includes determining whether the match expression is logically true according to the logical combination of the attribute condition statements defined in the match expression. The API gateway may then identify a particular routing object based on the matching operation and route the API message accordingly, adhering to defined policies such as rate-limiting, authentication, and security measures. Due to the expressive nature of the routing DSL, the API gateway can improve runtime performance of matching operations with routing data objects and determine how to route a given API request. Thus, various technical benefits are provided by embodiments disclosed herein.

### Egress Control

In some embodiments, the API gateway may include an egress control feature. Egress control is a manner of automatically reformatting inputs or responses received by an API gateway without requiring extensive modifications from an application sending the input or response, allowing for flexible integration with other applications that a developer desires to receive differently formatted input. For example, upon receiving input from a client application, an API gateway with an egress control feature may inspect the input using a predetermined set of criteria. The predetermined set of criteria, in some embodiments, is designed to scrutinize various aspects of the input, such as syntactic, semantic, or contextual attributes. The predetermined set of criteria, in some embodiments, assesses whether the input satisfies specified standards, thereby evaluating the appropriateness of the input for downstream processing. Inputs, in some embodiments, undergo feature extraction or semantic analysis, allowing the API gateway to discern contextual elements and adjust the input based on the predetermined set of criteria.

In some embodiments, the downstream processing is consuming a generative artificial intelligence (AI) API. Many AI applications involve processing data that potentially contains trade secrets, strategic business insights, or confidential customer details. Without security measures, organizations expose themselves to the potential loss or compromise of sensitive information, potentially leading to reputational damage or legal ramifications. Maintaining the confidentiality of sensitive information is especially pertinent as AI applications often deal with sensitive data, making them attractive targets for cyber adversaries. To foster trust and compliance, effective AI governance necessitates the ability to regulate information flow, sanitize data to prevent sensitive information leakage, and ensure responsible AI adoption within organizational boundaries. One solution to controlling the performance of generative AI applications is the egress control feature, which modifies the outbound flow of data from the client application to external entities, such as specialized AI providers for specific tasks (such as Cohere), cloud-based AI providers (such as OpenAI), or self-hosted AI providers (such as Mistral). The egress process becomes particularly complex when dealing with multiple generative AI models from different providers, each with a unique set of features, formats, and interfaces. The egress control feature addresses this problem by enabling the dynamic reformatting of inputs and responses such that appropriately formatted information with the desired degree of confidentiality is routed to each AI model without burdening the client application with the intricacies of adapting to each model's features.

In some embodiments, an API gateway with an egress control feature interconnects a client application with multiple generative AI providers. In such embodiments, the API gateway receives user input from a client application signifying a user query for a selected AI model and also designating the selected AI provider from the multiple generative AI providers. When user input is received, the API gateway assesses the user input against predetermined criteria to ensure compatibility with the selected AI provider specified by the user. For example, the criteria may compare the response size of the user input to the response size limit for the selected AI provider. The user input is then adjusted in real time to conform to the input format required by the selected AI provider and routed to that provider. In some embodiments, the adjustments include modifying the user input to ensure that the adjusted input aligns with the input format mandated by the selected AI provider. The adjusted input may be routed through a session layer (L5), a presentation layer (L6), or an application layer (L7) of an Open Systems Interconnection (OSI) model.

### Gateway Customization

As may be appreciated from the foregoing, an API gateway may include numerous complex features, with each additional feature adding additional complexity to the gateway. Features of an API gateway include the aspects and/or functionalities of API gateways described above (e.g., event hook processing and configuration setting comparisons of a control plane, programmable data plane, auto-documentation, self-healing, routing DSL, egress control), as well as additional API gateway features known in the art (e.g., the core set of functionalities described in relation to FIG. 1B above). Existing gateway technologies are limited in their ability to exclude features that are not desired or that are not relevant to a particular microservices application deployment. Thus, developers using these gateway technologies may struggle to understand the operations of the gateways and be unable to customize those gateways to match the demands of a particular microservices application. Additional complexity may be introduced due to various features of an API gateway being interrelated/interdependent such that the inclusion of a feature and/or the particular configuration of that feature necessitates the inclusion/exclusion of certain other features or a particular configuration of those features in order for the API gateway to function as intended. Without a tool accounting for the interdependencies between gateway features, developers may struggle to modify an API gateway without disrupting interdependencies and thereby causing errors in the operation of the API gateway.

In some embodiments, the set of features included in an API gateway as disclosed herein are customizable, with the features being selected from an electable set of API gateway features, allowing needless complexity to be reduced while maintaining the features that are desirable for a particular microservices application. In such embodiments, a desired set of features may be selected by a user via a GUI including one or more blocks representing available features of the API gateway. In other embodiments, the set of features are instead available for a customizable event gateway that may be customized via a similar GUI. An event gateway is generally similar to an API gateway except that an event gateway routes events from publishers to subscribers rather than routing requests from clients to services. The routing of an event gateway is asynchronous with respect to receiving an event, enabling events to be modified before routing and promoting decoupled service interactions. Thus, by providing API and/or event gateways that are customized to a particular microservices application, the present technology enables increased accessibility and flexibility in the development of microservices applications as compared to existing technologies.

Although, in the embodiments described above, gateway features may be added or removed from a gateway similarly to plugins, these features are not themselves plugins. Unlike with plugins, the features are not distributed separately from the gateways in which they may be included, and the addition or removal of a feature may necessitate changes to the rest of the gateway (e.g., redesigns or recompilations of the gateway). However, the disclosed technology does provide a degree of modularity for gateway features (subject to interdependencies between features) that is not present in existing gateway technologies where gateways include a predefined set of features that cannot be customized.

FIG. 11 is an illustration of an example gateway customization GUI 1100 for selecting features to include in an API gateway. The gateway customization GUI 1100 is a block-based programming interface enabling a user to select one or more blocks 1106 from a feature bank 1102 to attach to an API gateway indicator 1104. As depicted in FIG. 11, the feature bank 1102 contains a plurality of blocks 1106, which are visual representations of the features that may be included in a customized API gateway. The protruding portion of the blocks 1106, which fits within the recesses of the API gateway indicator 1104, visually indicates that the features represented by/associated with the blocks 1106 may be included in an API that is generated based on the selections made via the gateway customization GUI 1100. For example, block 1106F is associated with the auto-documentation API gateway feature (as indicated by the text “Auto-Documentation” on block 1106F) and the connection between block 1106F and the API gateway indicator 1104 (e.g., the insertion of the protruding portion of block 1106F into a recess of the API gateway indicator 1104) signifies that an API gateway configured via the gateway customization GUI 1100 will include the auto-documentation functionality. However, because blocks 1106A, 1106B, and 1106C, representing the, programmable data plane, event hook, and routing DSL API gateway features, respectively, remain in the feature bank 1102, these features will not be included in the API gateway being configured in FIG. 11, although they may be included in other gateways when different selections are made by the user.

In some embodiments, certain features are dependent on other features and therefore may only be included in an API gateway together with the other feature or features on which those features depend. To represent these dependencies visually and automatically account for interdependencies of which a user might not be aware, the gateway customization GUI 1100 may include a block 1106 that is connected to another block upon which the block 1106 depends. For example, as depicted in FIG. 10, block 1106E (representing an AI egress point feature, which is a specific egress control feature) depends on block 1106D (representing general egress control features), as the AI egress point feature would not function properly within an API gateway without aspects of the more general egress control feature also being included. Additionally, block 1106E is restricted such that it cannot be moved (e.g., selected by the user and dragged with a mouse cursor) within the gateway customization GUI 1100 without being connected to block 1106D, visually signifying that block 1106E cannot be connected to the API gateway indicator 1104 without being connected via block 1106D and paralleling the operation of the features themselves (e.g., the AI egress point feature cannot be deployed in an API gateway without the general egress control features).

In these and other embodiments, certain features may be incompatible with other features and the gateway customization GUI 1100 may include a visual indicator signaling that when a block 1106 representing a feature is connected to the API gateway indicator 1104, blocks 1106 representing incompatible features cannot also be attached, thereby resulting in a faulty API gateway deployment due to the inclusion of incompatible features. Additionally or alternatively, when an interdependency between two features exists such that a particular configuration of one feature must be implemented in order for the other feature to be included in the gateway, configuring the gateway includes automatically identifying this particular configuration and including the configuration in the gateway. For example, configuration 1 of an auto-documentation feature may be included in an API gateway by default, but when a routing DSL feature is also included in the API gateway, then configuration 2 of the auto-documentation feature is included instead due to an interdependency between the two features. As another example, one or more features may depend on configuration 2 of the auto-documentation feature while being incompatible with other configurations of the auto-documentation feature. In such an example, a block 1106 representing the one or more features may only be connected to the API gateway indicator 1104 by being connected to block 1106F representing the auto-documentation feature, and when the API gateway is configured, it will be configured to include configuration 2 of the auto-documentation feature. The various interdependencies and/or incompatibilities between gateway features described above add complexity to the gateway configuration process, but visual indicators within the gateway customization GUI 1100 intuitively guide the user as to which features to include in a customized gateway, reducing the burden of manually configuring a gateway where certain features depend on and/or conflict with other features.

Although FIG. 11 depicts the customization of an API gateway, the present technology is not so limited. An event gateway may likewise be customized via a GUI in a generally similar manner to the gateway customization GUI 1100 described above but with the API gateway indicator 1104 being replaced with an indicator of an event gateway, with the indicator having the same or generally similar recesses indicating the blocks 1106 may be connected to the indicator, thereby causing the represented features to be added to the event gateway. In some embodiments, the features that may be included in an event gateway include the features described herein in relation to API gateways and/or additional features.

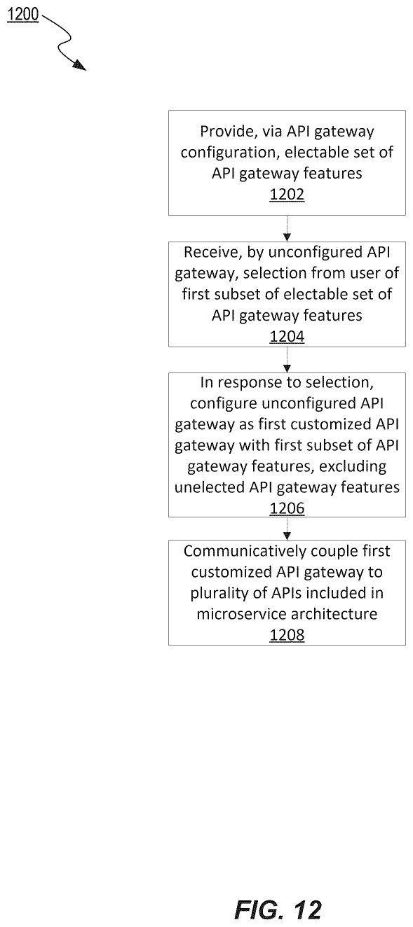

FIG. 12 is a flowchart illustrating a method 1200 for deploying a customized API gateway. In step 1202, an electable set of API gateway features is provided via an API gateway configuration. The API gateway features are features that may be included in an API gateway that operate on API traffic at an application layer (e.g., L7 of the OSI model). The API gateway configuration is a software component of an API gateway that provides an interface by which the gateway can be configured. For example, the API gateway configuration may provide a command prompt interface or a GUI.

In step 1204, a selection is received, by an unconfigured API gateway and from a user, of a first subset of the electable set of API gateway features. The selection is an instruction to the API gateway configuration to include the first subset of API gateway features in a first customized API gateway. In some embodiments, the electable set of API gateway features includes an event hook processing feature, a configuration setting comparison feature, a programmable data plane feature, an auto-documentation feature, a self-healing feature, a routing domain-specific language feature, an egress control feature, and/or another feature of a gateway.

In some embodiments where the API gateway configuration provides a GUI, the GUI includes a set of representations, with each representation being associated with an API gateway feature. In such embodiments, the selection of the first subset is received from the user via the GUI. In these and other embodiments, each representation in the set of representations is depicted within the GUI as a block including a visual indication that the block connects to an API gateway indicator. For example, the GUI may be the same as or generally similar to the gateway customization GUI 1100 described above in relation to FIG. 12 and include blocks 1106 and/or an API gateway indicator 1104 as illustrated in FIG. 12. In such embodiments, the selection may include the user connecting, via the GUI, the first subset of the set of representations to the API gateway indicator. For example, the representations in the first subset may be blocks and the user may connect the first subset to an API gateway indicator by selecting and dragging (e.g., using a mouse cursor) each block in the first subset to be connected to the API gateway indicator (e.g., as described in relation to the blocks 1106 and API gateway indicator 1104 of FIG. 12). Additionally or alternatively, a first representation from the set of representations may only be selectable in conjunction with a second representation from the set of representations, indicating that a first feature associated with the first representation is dependent on a second feature associated with the second representation and would not function properly within an API gateway without the second feature.

In step 1206, the unconfigured API gateway is configured as a first customized API gateway in response to the selection received in step 1204. The first customized API gateway is configured with the first subset of API gateway features, excluding unelected API gateway features. In other words, the first customized API gateway will include one or more of the API gateway features in the first subset but not other features in the electable set of API gateway features that were not selected as part of the first subset. In some embodiments where one or more of the API gateway features in the first subset are incompatible with another feature in the first subset, those one or more features may be automatically excluded when the first customized API gateway is configured. Additionally or alternatively, when an interdependency between two features exists such that a first API gateway feature is only compatible with a particular configuration of a second API gateway feature, configuring the gateway includes automatically identifying this interdependency and including the first API gateway feature and the particular configuration of the second API gateway feature in the first customized API gateway.

In some embodiments, the unconfigured API gateway is communicatively coupled with a plurality of APIs before it is configured as the first customized API gateway. Thus, an existing gateway is modified to include the gateway features associated with the first subset rather than a new gateway being generated from scratch. Additionally or alternatively, the first customized API gateway may be configured to include a set of default features that is independent of the selected first subset of API gateway features. For example, the set of default features may be features without which the gateway would not be functional and/or may be included in the generated customized API gateway regardless of the received selection.

In step 1208, the first customized API gateway is communicatively coupled to a first plurality of APIs included in a microservices application architecture. The microservices application architecture includes a plurality of independent services. These independent services interact with each other via APIs to perform an overall application function and include API traffic that passes through the first customized API gateway. In some embodiments, communicatively coupling the first customized API gateway to the first plurality of APIs may include configuring the first customized API gateway to receive data from and/or transmit data to the first plurality of APIs via a control plane and/or data plane proxy.

In some embodiments, multiple gateways, being either customized or preconfigured, may be deployed to the same microservices application (e.g., communicatively coupled to APIs in the same microservices application). For example, a second customized API gateway may be generated in the same manner described above, except that a different set of features may be selected for inclusion in the second customized API gateway than the first customized API gateway. Continuing with the same example, the second customized API gateway may be communicatively coupled to a second plurality of APIs in the microservices application architecture that is associated with a different functionality (e.g., interfaces with a different application or otherwise performs a different role) than the first plurality of APIs, enabling both customized API gateways to manage different parts/functionalities of the overall application. As an additional example, a condition of the microservices application architecture (e.g., a certain state of the application during execution associated with the core set of functionalities of a gateway, such as a certain load being processed or a certain security level) may be determined under which a second API gateway (which may be customized or have a predetermined set of features) should be communicatively coupled to the first plurality of APIs instead of the first customized API gateway. Continuing with the same example, the first customized API gateway may be decoupled from the first plurality of APIs and the second API gateway may then be communicatively coupled to the first plurality of APIs, effectively replacing the first customized API gateway with another gateway better suited to the condition of the microservices application architecture.

Although FIG. 12 describes the deployment of a customized API gateway, the present technology is not so limited. An event gateway may likewise be deployed using the same or generally similar steps to steps 1202-1206 described above but with the API gateway instead being an event gateway. In some embodiments, the features that may be included in the event gateway include the features described herein in relation to API gateways and/or additional features.

### Computing Platform

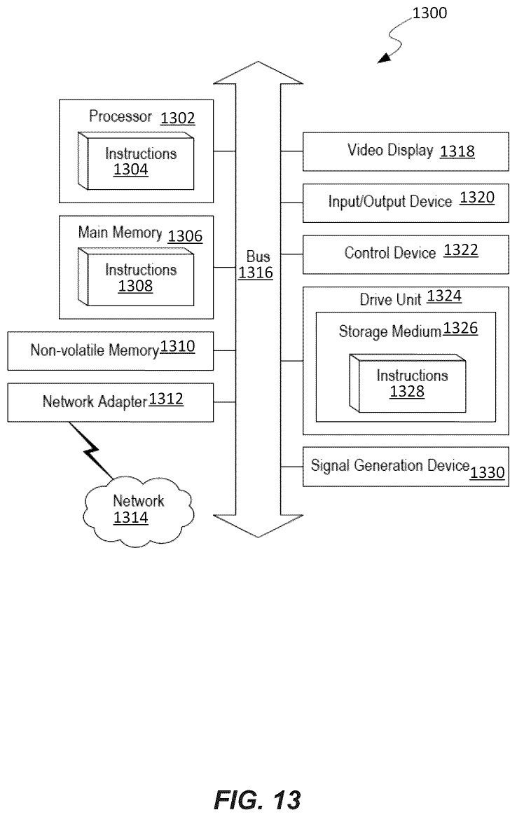

FIG. 13 is a block diagram illustrating an example computer system 1300 in accordance with one or more embodiments. In some embodiments, components of the example computer system 1300 are used to implement the software platforms described herein. At least some operations described herein can be implemented on the computer system 1300.

In some embodiments, the computer system 1300 includes one or more central processing units (“processors”) 1702, main memory 1306, non-volatile memory 1310, network adapters 1312 (e.g., network interface), video displays 1318, input/output devices 1320, control devices 1322 (e.g., keyboard and pointing devices), drive units 1324 including a storage medium 1326, and a signal generation device 1320 that are communicatively connected to a bus 1316. The bus 1316 is illustrated as an abstraction that represents one or more physical buses and/or point-to-point connections that are connected by appropriate bridges, adapters, or controllers. The bus 1316, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1794 bus (also referred to as “Firewire”).

In some embodiments, the computer system 1300 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1300.

While the main memory 1306, non-volatile memory 1310, and storage medium 1326 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1328. The term “machine-readable medium” and “storage medium” shall also be taken to include any medium that is capable of storing, encoding, or carrying a set of instructions for execution by the computer system 1300. In some embodiments, the non-volatile memory 1310 or the storage medium 1326 is a non-transitory, computer-readable storage medium storing computer instructions, which is executable by one or more “processors” 1302 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1304, 1308, 1328) set at various times in various memory and storage devices in a computer device. When read and executed by one or more processors 1302, the instruction(s) cause the computer system 1300 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1310, floppy and other removable disks, hard disk drives, optical discs (e.g., compact disc read-only memory (CD-ROMS), digital versatile discs (DVDs)), and transmission-type media such as digital and analog communication links.

The network adapter 1312 enables the computer system 1300 to mediate data in a network 1314 with an entity that is external to the computer system 1300 through any communication protocol supported by the computer system 1300 and the external entity. The network adapter 1312 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1312 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example AI system 1400 illustrated and described in more detail with reference to FIG. 18.

### AI System

FIG. 14 is a high-level block diagram illustrating an example AI system in accordance with one or more embodiments. The AI system 1400 is implemented using components of the example computer system 1300 illustrated and described in more detail with reference to FIG. 13. Likewise, embodiments of the AI system 1400 include different and/or additional components or be connected in different ways.

In some embodiments, as shown in FIG. 14, the AI system 1400 includes a set of layers, which conceptually organize elements within an example network topology for the AI system's architecture to implement a particular AI model 1430. Generally, an AI model 1430 is a computer-executable program implemented by the AI system 1400 that analyses data to make predictions. Information passes through each layer of the AI system 1400 to generate outputs for the AI model 1430. The layers include a data layer 1402, a structure layer 1404, a model layer 1406, and an application layer 1408. The algorithm 1416 of the structure layer 1404 and the model structure 1420 and model parameters 1422 of the model layer 1406 together form the example AI model 1430. The optimizer 1426, loss function engine 1424, and regularization engine 1428 work to refine and optimize the AI model 1430, and the data layer 1402 provides resources and support for the application of the AI model 1430 by the application layer 1408.

The data layer 1402 acts as the foundation of the AI system 1400 by preparing data for the AI model 1430. As shown, in some embodiments, the data layer 1402 includes two sub-layers: a hardware platform 1410 and one or more software libraries 1412. The hardware platform 1410 is designed to perform operations for the AI model 1430 and includes computing resources for storage, memory, logic, and networking, such as the resources described in relation to FIG. 1. The hardware platform 1410 processes amounts of data using one or more servers. The servers can perform backend operations such as matrix calculations, parallel calculations, machine learning (ML) training, and the like. Examples of servers used by the hardware platform 1410 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1410 includes Infrastructure as a Service (IaaS) resources, which are computing resources (e.g., servers, memory, etc.) offered by a cloud services provider. In some embodiments, the hardware platform 1410 includes computer memory for storing data about the AI model 1430, application of the AI model 1430, and training data for the AI model 1430. In some embodiments, the computer memory is a form of random-access memory (RAM), such as dynamic RAM, static RAM, and non-volatile RAM.

In some embodiments, the software libraries 1412 are thought of as suites of data and programming code, including executables, used to control the computing resources of the hardware platform 1410. In some embodiments, the programming code includes low-level primitives (e.g., fundamental language elements) that form the foundation of one or more low-level programming languages, such that servers of the hardware platform 1410 can use the low-level primitives to carry out specific operations. The low-level programming languages do not require much, if any, abstraction from a computing resource's instruction set architecture, allowing them to run quickly with a small memory footprint. Examples of software libraries 1412 that can be included in the AI system 1400 include Intel Math Kernel Library, Nvidia cuDNN, Eigen, and Open BLAS.

In some embodiments, the structure layer 1404 includes an ML framework 1414 and an algorithm 1416. The ML framework 1414 can be thought of as an interface, library, or tool that allows users to build and deploy the AI model 1430. In some embodiments, the ML framework 1414 includes an open-source library, an application programming interface (API), a gradient-boosting library, an ensemble method, and/or a deep learning toolkit that works with the layers of the AI system to facilitate development of the AI model 1430. For example, the ML framework 1414 distributes processes for the application or training of the AI model 1430 across multiple resources in the hardware platform 1410. In some embodiments, the ML framework 1414 also includes a set of pre-built components that have the functionality to implement and train the AI model 1430 and allow users to use pre-built functions and classes to construct and train the AI model 1430. Thus, the ML framework 1414 can be used to facilitate data engineering, development, hyperparameter tuning, testing, and training for the AI model 1430. Examples of ML frameworks 1414 that can be used in the AI system 1400 include TensorFlow, PyTorch, Scikit-Learn, Keras, Caffe, LightGBM, Random Forest, and Amazon Web Services.

In some embodiments, the algorithm 1416 is an organized set of computer-executable operations used to generate output data from a set of input data and can be described using pseudocode. In some embodiments, the algorithm 1416 includes complex code that allows the computing resources to learn from new input data and create new/modified outputs based on what was learned. In some implementations, the algorithm 1416 builds the AI model 1430 by being trained while running computing resources of the hardware platform 1410. The training allows the algorithm 1416 to make predictions or decisions without being explicitly programmed to do so. Once trained, the algorithm 1416 runs at the computing resources as part of the AI model 1430 to make predictions or decisions, improve computing resource performance, or perform tasks. The algorithm 1416 is trained using supervised learning, unsupervised learning, semi-supervised learning, and/or reinforcement learning.

The application layer 1408 describes how the AI system 1400 is used to solve problems or perform tasks. In an example implementation, egress web gateway uses the application layer 1408 to intercept communication between the client application 104 and generative AI API 108.

As an example, to train an AI model 1430 that is intended to model human language (also referred to as a language model), the data layer 1402 is a collection of text documents referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1402 is annotated with ground truth labels (e.g., each data entry in the training dataset is paired with a label) or unlabeled.

Training an AI model 1430 generally involves inputting into an AI model 1430 (e.g., an untrained ML model) data layer 1402 to be processed by the AI model 1430, processing the data layer 1402 using the AI model 1430, collecting the output generated by the AI model 1430 (e.g., based on the inputted training data), and comparing the output to a desired set of target values. If the data layer 1402 is labeled, the desired target values, in some embodiments, are, e.g., the ground truth labels of the data layer 1402. If the data layer 1402 is unlabeled, the desired target value is, in some embodiments, a reconstructed (or otherwise processed) version of the corresponding AI model 1430 input (e.g., in the case of an autoencoder) or is a measure of some target observable effect on the environment (e.g., in the case of a reinforcement learning agent). The parameters of the AI model 1430 are updated based on a difference between the generated output value and the desired target value. For example, if the value outputted by the AI model 1430 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1430 typically is to minimize a loss function or maximize a reward function.

In some embodiments, the data layer 1402 is a subset of a larger dataset. For example, a dataset is split into three mutually exclusive subsets: a training set, a validation (or cross-validation) set, and a testing set. The three subsets of data, in some embodiments, are used sequentially during AI model 1430 training. For example, the training set is first used to train one or more ML models, each AI model 1430, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger dataset and/or schemes for using the segments for training one or more ML models are possible.

Backpropagation is an algorithm for training an AI model 1430. Backpropagation is used to adjust (also referred to as update) the value of the parameters in the AI model 1430, with the goal of optimizing the objective function. For example, a defined loss function is calculated by forward propagation of an input to obtain an output of the AI model 1430 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1430 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1430 is sufficiently converged with the desired target value), after which the AI model 1430 is considered to be sufficiently trained. The values of the learned parameters are then fixed, and the AI model 1430 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1430 typically involves further training the ML model on a number of data samples (which may be smaller in number/cardinality than those used to train the model initially) that closely target the specific task. For example, an AI model 1430 for generating natural language that has been trained generically on publicly available text corpora is, e.g., fine-tuned by further training using specific training samples. In some embodiments, the specific training samples are used to generate language in a certain style or a certain format. For example, the AI model 1430 is trained to generate a blog post having a particular style and structure with a given topic.

Some concepts in ML-based language models are now discussed. It may be noted that while the term “language model” has been commonly used to refer to an ML-based language model, there could exist non-ML language models. In the present disclosure, the term “language model” may be used as shorthand for an ML-based language model (i.e., a language model that is implemented using a neural network or other ML architecture) unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

I/We claim:

1. A method for orchestrating an execution order of a plurality of application programming interfaces (APIs) using an API gateway to a microservices application, the method comprising:
receiving, at the API gateway, a set of API orchestration conditions from a user, wherein the API orchestration conditions specify a relative order in which one or more APIs from the plurality of APIs execute, wherein the API orchestration conditions are indicated via a low-code or no-code format, and wherein the one or more APIs communicatively couple independent services within the microservices application;
converting, by the API gateway, the set of API orchestration conditions into executable code that, when executed, assigns API requests and responses received at the API gateway to execute in a specific order, wherein the specific order includes a relative order of execution for a plurality of unexecuted API requests and API responses and is based on the set of API orchestration conditions;
receiving, at the API gateway, an API request from a client, wherein the API request is a request for an API from the plurality of APIs to execute; and
executing the executable code, thereby assigning the API request to execute according to the specific order.

2. The method of claim 1, wherein the set of API orchestration conditions includes at least one of:
a rule to execute the API prior to execution of a second API;
a rule to execute the API after execution of a third API;
a rule to execute the API prior to execution of all APIs in the plurality of APIs;
a rule to execute the API after execution of all APIs in the plurality of APIs;
a rule to execute the API prior to execution of a first functional group of APIs; or
a rule to execute the API after execution of a second functional group of APIs.

3. The method of claim 1, wherein the set of API orchestration conditions is indicated in a no-code format via a block-based programming graphical user interface (GUI), and wherein the block-based programming GUI includes one or more blocks arranged by the user to represent the set of API orchestration conditions.

4. The method of claim 1, wherein the set of API orchestration conditions is indicated in a no-code format via a natural language input to an AI model, wherein the natural language input includes a description of the set of API orchestration conditions, and the method further comprising:
receiving, by the API gateway, from the AI model, a programmable data plane script based on the set of API orchestration conditions; and
interpreting, by the API gateway, the programmable data plane script to convert the set of API orchestration conditions into executable code.

5. The method of claim 1, wherein the set of API orchestration conditions is indicated in a low-code format via a text interface, and wherein the text interface includes one or more scripts entered by the user, the scripts comprising incomplete code for the set of API orchestration conditions.

6. The method of claim 1, further comprising:
updating, by the API gateway, the specific order based on a change in condition of the microservices application.

7. The method of claim 1, further comprising:
sending, via the API gateway, a second API request to a second API, wherein the second API request is earlier in the specific order than the API request;
receiving, via the API gateway, a response from the second API; and
providing, via the API gateway, the response to the API as input.

8. A non-transitory, computer-readable storage medium comprising instructions recorded thereon, wherein the instructions, when executed by at least one data processor of a system, cause the system to:
receive, at an API gateway, a set of API orchestration conditions from a user, wherein the API orchestration conditions specify a relative order in which one or more APIs from a plurality of APIs execute, wherein the API orchestration conditions are indicated via a low-code or no-code format, and wherein the one or more APIs communicatively couple independent services within a microservices application;
convert, by the API gateway, the set of API orchestration conditions into executable code that, when executed, assigns API requests and responses received at the API gateway to execute in a specific order, wherein the specific order includes a relative order of execution for a plurality of unexecuted API requests and API responses and is based on the set of API orchestration conditions;
receive, at the API gateway, an API request from a client, wherein the API request is a request for an API from the plurality of APIs to execute; and
execute the executable code, thereby assigning the API request to execute according to the specific order.

9. The non-transitory, computer-readable storage medium of claim 8, wherein the set of API orchestration conditions includes at least one of:
a rule to execute the API prior to execution of a second API;
a rule to execute the API after execution of a third API;
a rule to execute the API prior to execution of all APIs in the plurality of APIs;
a rule to execute the API after execution of all APIs in the plurality of APIs;
a rule to execute the API prior to execution of a first functional group of APIs; or
a rule to execute the API after execution of a second functional group of APIs.

10. The non-transitory, computer-readable storage medium of claim 8, wherein the set of API orchestration conditions is indicated in a no-code format via a block-based programming graphical user interface (GUI), and wherein the block-based programming GUI includes one or more blocks arranged by the user to represent the set of API orchestration conditions.

11. The non-transitory, computer-readable storage medium of claim 8, wherein the set of API orchestration conditions is indicated in a no-code format via a natural language input to an AI model, wherein the natural language input includes a description of the set of API orchestration conditions, and wherein the API gateway receives, from the AI model, a programmable data plane script based on the set of API orchestration conditions.

12. The non-transitory, computer-readable storage medium of claim 8, wherein the set of API orchestration conditions is indicated in a low-code format via a text interface, and wherein the text interface includes one or more scripts entered by the user, the scripts comprising incomplete code for the set of API orchestration conditions.

13. The non-transitory, computer-readable storage medium of claim 8, further comprising instructions to:
update, by the API gateway, the specific order based on a change in condition of the microservices application.

14. The non-transitory, computer-readable storage medium of claim 8, further comprising instructions to:
send, via the API gateway, a second API request to a second API, wherein the second API request is earlier in the specific order than the API request;
receive, via the API gateway, a response from the second API; and
provide, via the API gateway, the response to the API as input.

15. A system comprising:
at least one hardware processor; and
at least one non-transitory memory storing instructions, which, when executed by the at least one hardware processor, cause the system to:
receive, at an API gateway, a set of API orchestration conditions from a user, wherein the set of API orchestration conditions specify a relative order in which one or more APIs execute, wherein the one or more APIs communicatively couple independent services within a microservices application;
convert, by the API gateway, the set of API orchestration conditions into executable code that, when executed, assigns API requests and responses received at the API gateway to execute in a specific order;
receive, at the API gateway, an API request from a client, wherein the API request is a request for an API to execute; and
execute the executable code, thereby assigning the API request to execute according to the specific order.

16. The system of claim 15, wherein the set of API orchestration conditions includes at least one of:
a rule to execute the API prior to execution of a second API;
a rule to execute the API after execution of a third API;
a rule to execute the API prior to execution of all APIs in the plurality of APIs;
a rule to execute the API after execution of all APIs in the plurality of APIs;
a rule to execute the API prior to execution of a first functional group of APIs; or
a rule to execute the API after execution of a second functional group of APIs.

17. The system of claim 15, wherein the set of API orchestration conditions is indicated in a no-code format via a block-based programming graphical user interface (GUI), and wherein the block-based programming GUI includes one or more blocks arranged by the user to represent the set of API orchestration conditions.

18. The system of claim 15, wherein the set of API orchestration conditions is indicated in a no-code format via a natural language input to an AI model, wherein the natural language input includes a description of the set of API orchestration conditions, and wherein the API gateway receives, from the AI model, a programmable data plane script based on the set of API orchestration conditions.

19. The system of claim 15, wherein the set of API orchestration conditions is indicated in a low-code format via a text interface, and wherein the text interface includes one or more scripts entered by the user, the scripts comprising incomplete code for the set of API orchestration conditions.

20. The system of claim 15, further comprising instructions to:
update, by the API gateway, the specific order based on a change in condition of the microservices application.
